(19) United States
(12) Patent Application Publication
(10) Pub. No.: US 2014/0029858 A1
(43) Pub. Date: Jan. 30, 2014

(54) INTERFEROMETRIC MODULATORS AS DUAL FUNCTION ELECTRO-OPTIC AND ELECTRO-ACOUSTIC DEVICES

(71) Applicant: Yeh-Jiun Tung, Sunnyvale, CA (US)

(72) Inventor: Yeh-Jiun Tung, Sunnyvale, CA (US)

(73) Assignee: QUALCOMM MEMS TECHNOLOGIES, INC., San Diego, CA (US)

(21) Appl. No.: 13/562,154

(22) Filed: Jul. 30, 2012

(51) Int. Cl. G06K 9/68

(52) U.S. Cl. 382/218

(57) ABSTRACT

This disclosure provides systems, methods and apparatus, including computer programs encoded on computer storage media, for using acoustic artifact data produced through normal operation of interferometric modulator (IMOD) displays to convey data in addition to the graphical content displayed using an IMOD display panel. In one aspect, such acoustic artifact data may be used to fingerprint or authenticate graphical content displayed by an IMOD display panel. In another aspect, the actuation of IMODs in an IMOD display panel may be modulated to produce a desired acoustic artifact data stream that may communicate information independently of, and simultaneously with, the display of graphical content.

### TECHNICAL FIELD

This disclosure relates to interferometric modulator (IMOD) electromechanical systems. This disclosure further relates to techniques and devices that may detect and utilize acoustic artifacts produced by state changes in IMODs.

### DESCRIPTION OF THE RELATED TECHNOLOGY

Electromechanical systems include devices having electrical and mechanical elements, actuators, transducers, sensors, optical components (e.g., mirrors) and electronics. Electromechanical systems can be manufactured at a variety of scales including, but not limited to, microscales and nanoscales. For example, microelectromechanical systems (MEMS) devices can include structures having sizes ranging from about a micron to hundreds of microns or more. Nanoelectromechanical systems (NEMS) devices can include structures having sizes smaller than a micron including, for example, sizes smaller than several hundred nanometers. Electromechanical elements may be created using deposition, etching, lithography, and/or other micromachining processes that etch away parts of substrates and/or deposited material layers, or that add layers to form electrical and electromechanical devices.

One type of electromechanical systems device is called an interferometric modulator (IMOD). As used herein, the term interferometric modulator or interferometric light modulator refers to a device that selectively absorbs and/or reflects light using the principles of optical interference. In some implementations, an interferometric modulator may include a pair of conductive plates, one or both of which may be transparent and/or reflective, wholly or in part, and capable of relative motion upon application of an appropriate electrical signal. In an implementation, one plate may include a stationary layer deposited on a substrate and the other plate may include a metallic membrane separated from the stationary layer by an air gap. The position of one plate in relation to another can change the optical interference of light incident on the interferometric modulator. Interferometric modulator devices have a wide range of applications, and are anticipated to be used in improving existing products and creating new products, especially those with display capabilities.

### SUMMARY

The systems, methods and devices of the disclosure each have several innovative aspects, no single one of which is solely responsible for the desirable attributes disclosed herein. One innovative aspect of the subject matter described in this disclosure can be implemented in a variety of ways.

In some implementations, a method may be provided for performing an authentication process. The method may include detecting a first set of acoustic artifacts produced by state changes in interferometric modulator (IMOD) displays of an IMOD display panel arising from the display of a subject graphic by the IMOD display panel at a first time, comparing the first set of acoustic artifacts against reference data associated with the subject graphic, and performing an authentication process based, at least in part, on the comparing to authenticate at least one of the subject graphic and the IMOD display panel.

In some implementations, the method may further include causing a display of a first reference graphic by the IMOD display panel immediately prior to or immediately after the display of the subject graphic. The reference data may be further associated with the first reference graphic and the first set of acoustic artifacts may be produced by state changes in the IMODs of the IMOD display panel arising from the display of the subject graphic immediately after the first reference graphic or from the display of the first reference graphic immediately after the subject graphic.

In some further implementations, the method may include causing displays of second through Nth reference graphics on the IMOD display panel, where N may be an integer with a value of 2 or greater, and causing a display of the subject graphic on the IMOD display panel immediately prior to or immediately after the display of each of the second through Nth reference graphics. The method may also include detecting second through Nth sets of acoustic artifacts, each of the second through Nth sets of acoustic artifacts produced by state changes in the IMODs arising from the display of a corresponding reference graphic of the second through Nth reference graphics immediately prior to or immediately after the subject graphic and comparing each set of acoustic artifacts in the second through Nth sets of acoustic artifacts against the reference data. The reference data may be further associated with the second through Nth reference graphics, and the authentication process may be based in further part on the comparison of each set of acoustic artifacts in the second through Nth sets of acoustic artifacts against the reference data.

In some implementations, each of the first through Nth reference graphics may differ from each of the other first through Nth reference graphics. In some implementations of the method, the reference data may include data derived from acoustic artifacts produced by state changes in the IMODs arising from the display of the subject graphic by the IMOD display panel at a second time earlier than the first time, and the authentication process may authenticate the IMOD display panel.

In some implementations, an apparatus may be provided. The apparatus may include an input interface and a controller. The controller may include at least one processor and at least one memory. The at least one memory may be operably connected with the at least one processor and may store instructions executable by the at least one processor. The instructions may include instructions to control the at least one processor to receive data from the input interface describing a first set of acoustic artifacts produced by state changes in interferometric modulator displays (IMODs) of an IMOD display panel arising from the display of a subject graphic by the IMOD display panel at a first time, compare the first set of acoustic artifacts against reference data associated with the subject graphic, and perform an authentication process based, at least in part, on the comparison of the first set of acoustic artifacts against reference data associated with the subject graphic to authenticate at least one of the subject graphic and the IMOD display panel.

In some implementations, the instructions stored on the at least one memory may further include instructions to control the at least one processor to cause a display of a first reference graphic by the IMOD display panel immediately prior to or immediately after the display of the subject graphic. The reference data may be further associated with the first reference graphic and the first set of acoustic artifacts may be produced by state changes in the IMODs of the IMOD display panel arising from the display of the subject graphic immediately after the first reference graphic or from the display of the first reference graphic immediately after the subject graphic.

In some implementations, the instructions stored on the at least one memory may further include instructions to control the at least one processor to cause displays of second through Nth reference graphics on the IMOD display panel, where N may be an integer with a value of 2 or greater, and cause a display of the subject graphic on the IMOD display panel immediately prior to or immediately after the display of each of the second through Nth reference graphics. The instructions may also include instructions to further control the at least one processor to receive data from the input interface describing second through Nth sets of acoustic artifacts, each of the sets of acoustic artifacts produced by state changes in the IMODs arising from the display of a corresponding reference graphic of the second through Nth reference graphics immediately prior to or immediately after the subject graphic and compare each set of acoustic artifacts in the second through Nth sets of acoustic artifacts against the reference data. The reference data may be further associated with the second through Nth reference graphics and the authentication process may be based in further part on the comparison of each set of acoustic artifacts in the second through Nth sets of acoustic artifacts against the reference data.

In some implementations of the apparatus, each of the first through Nth reference graphics differs from each of the other first through Nth reference graphics. In some apparatus implementations, the instructions may further include instructions to control the at least one processor to cause only N−1 displays of the subject graphic in order to produce the first through Nth sets of acoustic artifacts.

In some implementations, the reference data may include data derived from acoustic artifacts produced by state changes in the IMODs arising from the display of the subject graphic by the IMOD display panel at a second time earlier than the first time, and the authentication process may authenticate the IMOD display panel.

In some implementations, the apparatus may further include an acoustic detector. The acoustic detector may be configured to detect the first set of acoustic artifacts and communicate data describing the first set of acoustic artifacts to the at least one processor via the input interface.

In some implementations, the apparatus may further include the IMOD display panel, and the at least one processor may be communicatively connected with the IMOD display panel. The instructions may further include instructions to control the at least one processor to cause the display of the subject graphic on the IMOD display panel.

In some apparatus implementations, the apparatus may further include a driver circuit configured to send at least one signal to the IMOD display panel. Some implementations may include an image source module configured to send image data for the subject image to the controller. In some such implementations, the image source module may include at least one of a receiver, transceiver, and transmitter.

In some implementations, an apparatus is provided with means for detecting a first set of acoustic artifacts produced by state changes in interferometric modulator displays (IMODs) of an IMOD display panel arising from the display of a subject graphic by the IMOD display panel at a first time, means for comparing the first set of acoustic artifacts against reference data associated with the subject graphic, and means for performing an authentication process based, at least in part, on the comparing to authenticate at least one of the subject graphic and the IMOD display panel. In some further implementations, the apparatus may also include means for causing a display of a first reference graphic by the IMOD display panel immediately prior to or immediately after the display of the subject graphic. The reference data may be further associated with the first reference graphic and the first set of acoustic artifacts is produced by state changes in the IMODs arising from the display of the subject graphic immediately after the first reference graphic or from the display of the first reference graphic immediately after the subject graphic.

In some further implementations, the apparatus may also include means for causing displays of second through Nth reference graphics on the IMOD display panel, and N may be an integer with a value of 2 or greater. The apparatus may also include means for causing a display of the subject graphic on the IMOD display panel immediately prior to or immediately after the display of each of the second through Nth reference graphics, means for receiving data from the input interface describing second through Nth sets of acoustic artifacts, each of the sets of acoustic artifacts produced by state changes in the IMODs arising from the display of a corresponding reference graphic of the second through Nth reference graphics immediately prior to or immediately after the subject graphic, and means for comparing each set of acoustic artifacts in the second through Nth sets of acoustic artifacts against the reference data. The reference data may be further associated with the second through Nth reference graphics and the authentication process may be based in further part on the comparison of each set of acoustic artifacts in the second through Nth sets of acoustic artifacts against the reference data.

In some implementations, a machine-readable storage medium having software including computer-executable instructions stored thereon may be provided. The computer-executable instructions may include instructions for controlling one or more processors to receive a first set of acoustic artifacts produced by state changes in interferometric modulator displays (IMODs) of an IMOD display panel arising from the display of a subject graphic by the IMOD display panel at a first time, compare the first set of acoustic artifacts against reference data associated with the subject graphic, and perform an authentication process based, at least in part, on the comparing to authenticate at least one of the subject graphic and the IMOD display panel.

In some further implementations, the computer-executable instructions may further include instructions for controlling the one or more processors to cause a display of a first reference graphic by the IMOD display panel immediately prior to or immediately after the display of the subject graphic. The reference data may be further associated with the first reference graphic and the first set of acoustic artifacts may be produced by state changes in the IMODs arising from the display of the subject graphic immediately after the first reference graphic or from the display of the first reference graphic immediately after the subject graphic.

Some implementations may also include computer-executable instructions for controlling the one or more processors to cause displays of second through Nth reference graphics on the IMOD display panel, where N may be an integer with a value of 2 or greater, cause a display of the subject graphic on the IMOD display panel immediately prior to or immediately after the display of each of the second through Nth reference graphics, receive second through Nth sets of acoustic artifacts, each of the second through Nth sets of acoustic artifacts produced by state changes in the IMODs arising from the display of a corresponding reference graphic of the second through Nth reference graphics immediately prior to or immediately after the subject graphic, and compare each set of acoustic artifacts in the second through Nth sets of acoustic artifacts against the reference data. The reference data may be further associated with the second through Nth reference graphics, and the authentication process is based in further part on the comparing each set of acoustic artifacts in the second through Nth sets of acoustic artifacts against the reference data.

In some other implementations, an apparatus may be provided that includes an input interface, an output interface, and a controller operably connected with the input interface and the output interface. The controller may include at least one processor and at least one memory. The at least one memory may be operably connected with the at least one processor and may store instructions executable by the at least one processor. The instructions may include instructions to control the at least one processor to receive graphic content data via the input interface, receive acoustic content data via the input interface, where the acoustic content data may be independent of the graphic content data, and actuate, via the output interface, interferometric modulator displays (IMODs) in an IMOD display panel to display an image defined by the graphic content data and produce a time-varying number of acoustic artifacts correlating to the acoustic content data as the image is displayed.

In some further implementations, the at least one memory may store further instructions to control the at least one processor to actuate the IMODs such that, during each actuation cycle of the IMOD display panel, the number of acoustic artifacts produced by IMOD actuations in the cycle correlates with a portion of the acoustic content data. The instructions may further include instructions to control the at least one processor to actuate the IMODs such that portions of the image are displayed by IMODs during each actuation cycle, the portions, in aggregate, form the image, and all of the portions of the image are displayed over a time frame of about 60 ms or less.

In some implementations, the instructions may further include instructions to control the at least one processor to actuate the IMODs such that the image is displayed across a first region of the IMOD display panel during a first subset of actuation cycles for the IMOD display panel and the IMODs in a second region are, while the image is displayed across the first region, actuated during a second set of actuation cycles to produce the time-varying number of acoustic artifacts correlating to the acoustic content data, the second region separate from the first region and the second set of actuation cycles separate from the first set of actuation cycles.

In some implementations, the first region may include an interior region of the IMOD display panel, and the second region may include a peripheral region of the IMOD display panel.

In some other implementations, a machine-readable storage medium having software including computer-executable instructions stored thereon may be provided. The computer-executable instructions may include instructions for controlling one or more processors to receive graphic content data via the input interface, receive acoustic content data via the input interface, where the acoustic content data may be independent of the graphic content data, and actuate, via the output interface, interferometric modulator displays (IMODs) in an IMOD display panel to display an image defined by the graphic content data and produce a time-varying number of acoustic artifacts correlating to the acoustic content data as the image is displayed.

In some implementations, the computer-executable instructions may further include instructions for controlling the one or more processors to actuate the IMODs such that, during each actuation cycle of the IMOD display panel, the number of acoustic artifacts produced by IMOD actuations in the cycle correlates with a portion of the acoustic content data, portions of the image are displayed by IMODs during each actuation cycle, the portions, in aggregate, form the image, and all of the portions of the image are displayed over a time frame of about 60 ms or less.

In some implementations, the computer-executable instructions may further include instructions for controlling the one or more processors to actuate the IMODs such that the image is displayed across a first region of the IMOD display panel during a first set of actuation cycles for the IMOD display panel and the IMODs in a second region are, while the image is displayed across the first region, actuated during a second set of actuation cycles to produce the time-varying number of acoustic artifacts correlating to the acoustic content data, the second region separate from the first region and the second set of actuation cycles separate from the first set of actuation cycles. In some implementations, the first region may include an interior region of the IMOD display panel and the second region may include a peripheral region of the IMOD display panel.

Details of one or more implementations of the subject matter described in this specification are set forth in the accompanying drawings and the description below. Other features, aspects, and advantages will become apparent from the description, the drawings, and the claims. Note that the relative dimensions of the following figures may not be drawn to scale.

### BRIEF DESCRIPTION OF THE DRAWINGS

FIG. 1 shows an example of an isometric view depicting two adjacent pixels in a series of pixels of an interferometric modulator (IMOD) display device.

FIG. 2 shows an example of a system block diagram illustrating an electronic device incorporating a 3×3 interferometric modulator display.

FIG. 3 shows an example of a diagram illustrating movable reflective layer position versus applied voltage for the interferometric modulator of FIG. 1.

FIG. 4 shows an example of a table illustrating various states of an interferometric modulator when various common and segment voltages are applied.

FIG. 5A shows an example of a diagram illustrating a frame of display data in the 3×3 interferometric modulator display of FIG. 2.

FIG. 5B shows an example of a timing diagram for common and segment signals that may be used to write the frame of display data illustrated in FIG. 5A.

FIG. 6A shows an example of a partial cross-section of the interferometric modulator display of FIG. 1.

FIGS. 6B-6E show examples of cross-sections of varying implementations of interferometric modulators.

FIG. 7 shows an example of a flow diagram illustrating a manufacturing process for an interferometric modulator.

FIGS. 8A-8E show examples of cross-sectional schematic illustrations of various stages in a method of making an interferometric modulator.

FIG. 9A shows an example of graphical content that may be displayed using an IMOD display panel.

FIG. 9B shows the example of graphical content of FIG. 9A, but mirrored across a vertical axis.

FIG. 9C shows an example state change map for an example IMOD display panel that illustrates the pixels that would need to change state in the example IMOD display panel of FIGS. 9A and 9B between displaying the subject graphic of FIG. 9A and displaying the reference graphic of FIG. 9B.

FIG. 9D shows an example of several raster scan lines of IMOD state changes for the example IMOD display panel of FIG. 9C transitioning from displaying the reference graphic of FIG. 9B to displaying the subject graphic of FIG. 9A.

FIG. 9E shows an example plot of IMOD state changes v. IMOD element row for the example state change map of FIG. 9C.

FIG. 10 shows a plot of state changes that may occur in an example IMOD display panel when the example IMOD display panel is transitioned between a subject graphic and a series of reference images, as well as the subject graphic, reference graphics, and state change maps for transitioning between the subject graphic and reference graphics.

FIG. 11 depicts a flow diagram of a technique for obtaining acoustic artifact fingerprints or signatures of a subject graphic.

FIG. 12 depicts a flow diagram for one technique for evaluating the hardware of an IMOD display panel.

FIG. 13 depicts an example of a system block diagram illustrating an electronic device incorporating an IMOD display panel and an acoustic artifact detection system.

FIG. 14 depicts a series of images that may be displayed by an example IMOD display panel and that may also be used to communicate data via acoustic artifact emission.

FIG. 15 depicts a flow diagram for an example technique for transmitting data via acoustic artifacts while displaying graphical content on an IMOD display panel.

FIG. 16 depicts an example of an IMOD display panel with a peripheral region of IMODs reserved for acoustic artifact production and an interior region of IMODs reserved for graphical content display.

FIG. 17 shows another example of generating image frames that may be used to convey data via acoustic artifact production.

FIG. 18 depicts an example of a system block diagram illustrating an electronic device incorporating an IMOD display panel and an acoustic artifact provisioning system.

FIGS. 19A and 19B show examples of system block diagrams illustrating a display device that includes a plurality of interferometric modulators.

Like reference numbers and designations in the various drawings indicate like elements.

### DETAILED DESCRIPTION

The following detailed description is directed to certain implementations for the purposes of describing the innovative aspects. However, the teachings herein can be applied in a multitude of different ways. The described implementations may be implemented in any device that is configured to display an image, whether in motion (e.g., video) or stationary (e.g., still image), and whether textual, graphical or pictorial. More particularly, it is contemplated that the implementations may be implemented in or associated with a variety of electronic devices such as, but not limited to, mobile telephones, multimedia Internet enabled cellular telephones, mobile television receivers, wireless devices, smartphones, bluetooth devices, personal data assistants (PDAs), wireless electronic mail receivers, hand-held or portable computers, netbooks, notebooks, smartbooks, printers, copiers, scanners, facsimile devices, GPS receivers/navigators, cameras, MP3 players, camcorders, game consoles, wrist watches, clocks, calculators, television monitors, flat panel displays, electronic reading devices (e.g., e-readers), computer monitors, auto displays (e.g., odometer display, etc.), cockpit controls and/or displays, camera view displays (e.g., display of a rear view camera in a vehicle), electronic photographs, electronic billboards or signs, projectors, architectural structures, microwaves, refrigerators, stereo systems, cassette recorders or players, DVD players, CD players, VCRs, radios, portable memory chips, washers, dryers, washer/dryers, packaging (e.g., MEMS and non-MEMS), aesthetic structures (e.g., display of images on a piece of jewelry) and a variety of electromechanical systems devices. The teachings herein also can be used in non-display applications such as, but not limited to, electronic switching devices, radio frequency filters, sensors, accelerometers, gyroscopes, motion-sensing devices, magnetometers, inertial components for consumer electronics, parts of consumer electronics products, varactors, liquid crystal devices, electrophoretic devices, drive schemes, manufacturing processes, electronic test equipment. Thus, the teachings are not intended to be limited to the implementations depicted solely in the Figures, but instead have wide applicability as will be readily apparent to one having ordinary skill in the art.

IMOD display panels may feature large arrays of individual IMODs that can be configured into pixels and/or subpixels. Each of the IMODs may be individually moved between different display states. Each display state transition of an IMOD may produce an acoustic artifact, such as a “click” sound. The click sound may be detectable by a suitably sensitive and proximate microphone or other pressure or vibration detector. The magnitude of the “click” sound that is generated may be increased by moving groups of display elements between display states en masse. The “click” sounds/acoustic artifacts produced by IMODs contribute to the overall acoustic output of the IMOD display panel. In some IMOD display panels, IMODs may be actuated on a row-by-row basis. Depending on the number of state changes experienced by IMODs in each row, each such row actuation may generate a different acoustic output.

The generation of acoustic artifacts by IMODs may be exploited in two general ways. In the first, acoustic artifacts resulting from the display of graphical content on an IMOD display panel may be detected and processed; the IMOD controller controlling the IMOD display panel may take into account data describing graphical content but may not need to take into account data specifically describing any particular audio content. In the second, the IMOD controller may receive graphical data regarding graphical content to be displayed on the IMOD display panel and may also receive audio data regarding acoustic artifacts which are to be generated by the IMODs in the IMOD display panel. The IMOD controller may control the actuation of the IMODs in the IMOD display panel to produce the graphical content but may also control the actuation timing of the IMODs such that acoustic artifacts are produced in accordance with the audio data while still producing the graphical content.

Particular implementations of the subject matter described in this disclosure may be implemented to realize one or more of the following potential advantages. For example, the acoustic artifacts generated by display of graphical content on an IMOD display panel may produce a unique, or at least sufficiently unique, fingerprint of the graphical content that may be used to authenticate the graphical content or otherwise verify aspects of the graphical content.

Another potential advantage realized through various implementations of the subject matter described in this disclosure is that an IMOD display panel may be used to convey data in addition to graphical content by modulating the actuation of IMODs in the display panel to produce specific patterns of acoustic artifacts while simultaneously displaying, or appearing to display, the graphical content on the IMOD display. For example, while displaying a bar code on an IMOD display panel, the IMODs of the IMOD display panel may be actuated to also produce a string of acoustic artifacts that, when appropriately processed and decoded, may include the same code information as the visual bar code, but that may be detected even if the bar code graphic is partially obscured.

Another potential advantage realized through various implementations of the subject matter described in this disclosure is that the magnitudes of the acoustic artifacts may be used to assess the performance of the IMOD display. For example, dead pixels that receive actuation signals will not actuate and will not contribute to the generation of acoustic artifacts. Various other advantages may be apparent from the discussions below.

One example of a suitable MEMS device, to which the described implementations may apply, is a reflective display device. Reflective display devices can incorporate interferometric modulators (IMODs) to selectively absorb and/or reflect light incident thereon using principles of optical interference. IMODs can include an absorber, a reflector that is movable with respect to the absorber, and an optical resonant cavity defined between the absorber and the reflector. The reflector can be moved to two or more different positions, which can change the size of the optical resonant cavity and thereby affect the reflectance of the interferometric modulator. The reflectance spectrums of IMODs can create fairly broad spectral bands which can be shifted across the visible wavelengths to generate different colors. The position of the spectral band can be adjusted by changing the thickness of the optical resonant cavity, i.e., by changing the position of the reflector.

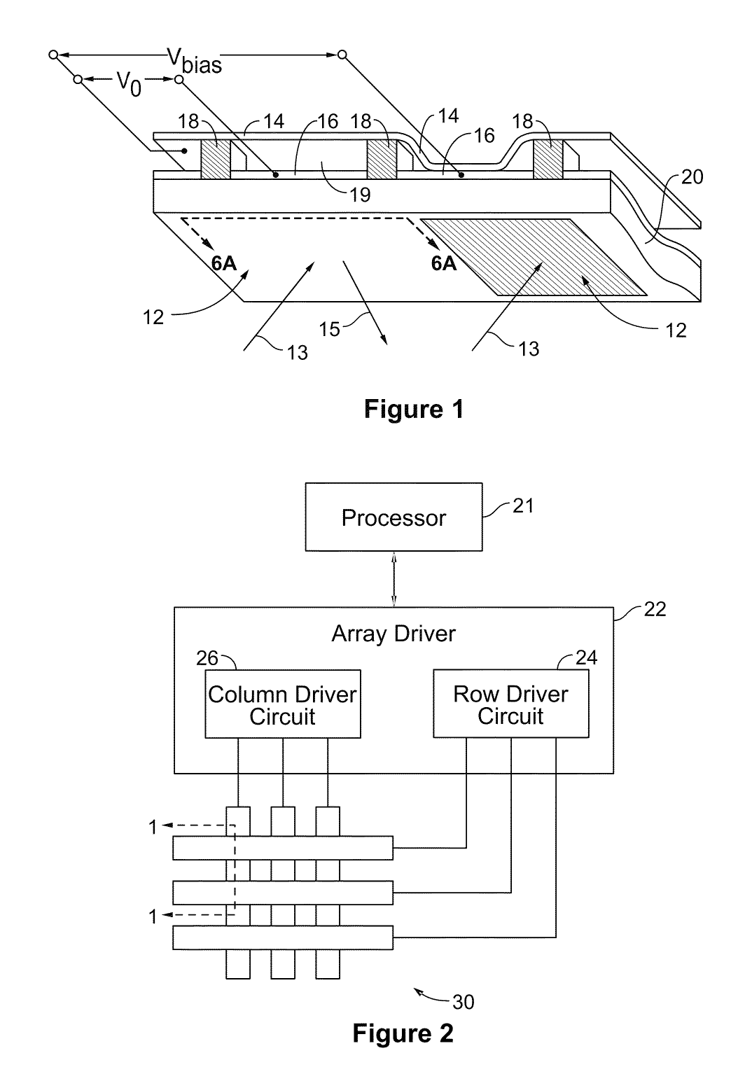

FIG. 1 shows an example of an isometric view depicting two adjacent pixels in a series of pixels of an interferometric modulator (IMOD) display device. The IMOD display device includes one or more interferometric MEMS display elements. In these devices, the pixels of the MEMS display elements can be in either a bright or dark state. In the bright (“relaxed,” “open” or “on”) state, the display element reflects a large portion of incident visible light, e.g., to a user. Conversely, in the dark (“actuated,” “closed” or “off”) state, the display element reflects little incident visible light. In some implementations, the light reflectance properties of the on and off states may be reversed. MEMS pixels can be configured to reflect predominantly at particular wavelengths allowing for a color display in addition to black and white.

The IMOD display device can include a row/column array of IMODs. Each IMOD can include a pair of reflective layers, i.e., a movable reflective layer and a fixed partially reflective layer, positioned at a variable and controllable distance from each other to form an air gap (also referred to as an optical gap or cavity). The movable reflective layer may be moved between at least two positions. In a first position, i.e., a relaxed position, the movable reflective layer can be positioned at a relatively large distance from the fixed partially reflective layer. In a second position, i.e., an actuated position, the movable reflective layer can be positioned more closely to the partially reflective layer. Incident light that reflects from the two layers can interfere constructively or destructively depending on the position of the movable reflective layer, producing either an overall reflective or non-reflective state for each pixel. In some implementations, the IMOD may be in a reflective state when unactuated, reflecting light within the visible spectrum, and may be in a dark state when unactuated, reflecting light outside of the visible range (e.g., infrared light). In some other implementations, however, an IMOD may be in a dark state when unactuated, and in a reflective state when actuated. In some implementations, the introduction of an applied voltage can drive the pixels to change states. In some other implementations, an applied charge can drive the pixels to change states.

The depicted portion of the pixel array in FIG. 1 includes two adjacent interferometric modulators 12. In the IMOD 12 on the left (as illustrated), a movable reflective layer 14 is illustrated in a relaxed position at a predetermined distance from an optical stack 16, which includes a partially reflective layer. The voltage V₀ applied across the IMOD 12 on the left is insufficient to cause actuation of the movable reflective layer 14. In the IMOD 12 on the right, the movable reflective layer 14 is illustrated in an actuated position near or adjacent the optical stack 16. The voltage V_{bias} applied across the IMOD 12 on the right is sufficient to maintain the movable reflective layer 14 in the actuated position.

In FIG. 1, the reflective properties of pixels 12 are generally illustrated with arrows 13 indicating light incident upon the pixels 12, and light 15 reflecting from the IMOD 12 on the left. Although not illustrated in detail, it will be understood by one having ordinary skill in the art that most of the light 13 incident upon the pixels 12 will be transmitted through the transparent substrate 20, toward the optical stack 16. A portion of the light incident upon the optical stack 16 will be transmitted through the partially reflective layer of the optical stack 16, and a portion will be reflected back through the transparent substrate 20. The portion of light 13 that is transmitted through the optical stack 16 will be reflected at the movable reflective layer 14, back toward (and through) the transparent substrate 20. Interference (constructive or destructive) between the light reflected from the partially reflective layer of the optical stack 16 and the light reflected from the movable reflective layer 14 will determine the wavelength(s) of light 15 reflected from the IMOD 12.

The optical stack 16 can include a single layer or several layers. The layer(s) can include one or more of an electrode layer, a partially reflective and partially transmissive layer and a transparent dielectric layer. In some implementations, the optical stack 16 is electrically conductive, partially transparent and partially reflective, and may be fabricated, for example, by depositing one or more of the above layers onto a transparent substrate 20. The electrode layer can be formed from a variety of materials, such as various metals, for example indium tin oxide (ITO). The partially reflective layer can be formed from a variety of materials that are partially reflective, such as various metals, e.g., chromium (Cr), semiconductors, and dielectrics. The partially reflective layer can be formed of one or more layers of materials, and each of the layers can be formed of a single material or a combination of materials. In some implementations, the optical stack 16 can include a single semi-transparent thickness of metal or semiconductor which serves as both an optical absorber and conductor, while different, more conductive layers or portions (e.g., of the optical stack 16 or of other structures of the IMOD) can serve to bus signals between IMOD pixels. The optical stack 16 also can include one or more insulating or dielectric layers covering one or more conductive layers or a conductive/absorptive layer.

In some implementations, the layer(s) of the optical stack 16 can be patterned into parallel strips, and may form row electrodes in a display device as described further below. As will be understood by one having skill in the art, the term “patterned” is used herein to refer to masking as well as etching processes. In some implementations, a highly conductive and reflective material, such as aluminum (Al), may be used for the movable reflective layer 14, and these strips may form column electrodes in a display device. The movable reflective layer 14 may be formed as a series of parallel strips of a deposited metal layer or layers (orthogonal to the row electrodes of the optical stack 16) to form columns deposited on top of posts 18 and an intervening sacrificial material deposited between the posts 18. When the sacrificial material is etched away, a defined gap 19, or optical cavity, can be formed between the movable reflective layer 14 and the optical stack 16. In some implementations, the spacing between posts 18 may be on the order of 1-1000 um, while the gap 19 may be on the order of <10,000 Angstroms (Å).

In some implementations, each pixel of the IMOD, whether in the actuated or relaxed state, is essentially a capacitor formed by the fixed and moving reflective layers. When no voltage is applied, the movable reflective layer 14 remains in a mechanically relaxed state, as illustrated by the IMOD 12 on the left in FIG. 1, with the gap 19 between the movable reflective layer 14 and optical stack 16. However, when a potential difference, e.g., voltage, is applied to at least one of a selected row and column, the capacitor formed at the intersection of the row and column electrodes at the corresponding pixel becomes charged, and electrostatic forces pull the electrodes together. If the applied voltage exceeds a threshold, the movable reflective layer 14 can deform and move near or against the optical stack 16. A dielectric layer (not shown) within the optical stack 16 may prevent shorting and control the separation distance between the layers 14 and 16, as illustrated by the actuated IMOD 12 on the right in FIG. 1. The behavior is the same regardless of the polarity of the applied potential difference. Though a series of pixels in an array may be referred to in some instances as “rows” or “columns,” a person having ordinary skill in the art will readily understand that referring to one direction as a “row” and another as a “column” is arbitrary. Restated, in some orientations, the rows can be considered columns, and the columns considered to be rows. Furthermore, the display elements may be evenly arranged in orthogonal rows and columns (an “array”), or arranged in non-linear configurations, for example, having certain positional offsets with respect to one another (a “mosaic”). The terms “array” and “mosaic” may refer to either configuration. Thus, although the display is referred to as including an “array” or “mosaic,” the elements themselves need not be arranged orthogonally to one another, or disposed in an even distribution, in any instance, but may include arrangements having asymmetric shapes and unevenly distributed elements.

FIG. 2 shows an example of a system block diagram illustrating an electronic device incorporating a 3×3 interferometric modulator display. The electronic device includes a processor 21 that may be configured to execute one or more software modules. In addition to executing an operating system, the processor 21 may be configured to execute one or more software applications, including a web browser, a telephone application, an email program, or other software application.

The processor 21 can be configured to communicate with an array driver 22. The array driver 22 can include a row driver circuit 24 and a column driver circuit 26 that provide signals to, e.g., a display array or panel 30. The cross section of the IMOD display device illustrated in FIG. 1 is shown by the lines 1-1 in FIG. 2. Although FIG. 2 illustrates a 3×3 array of IMODs for the sake of clarity, the display array 30 may contain a very large number of IMODs, and may have a different number of IMODs in rows than in columns, and vice versa.

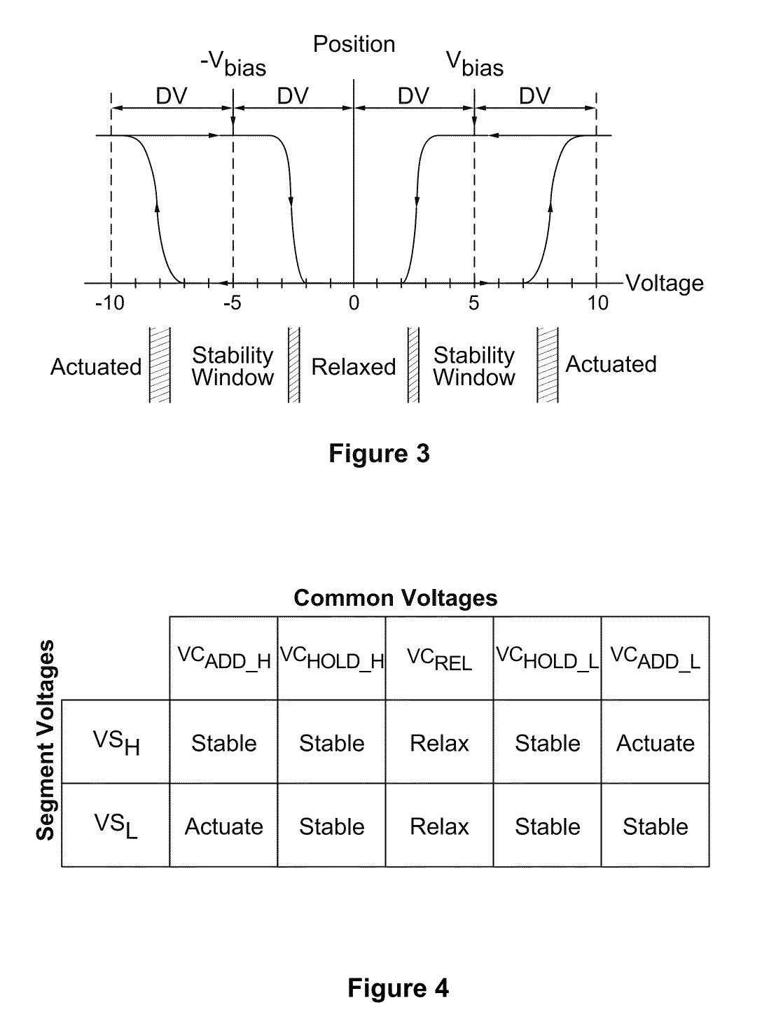

FIG. 3 shows an example of a diagram illustrating movable reflective layer position versus applied voltage for the interferometric modulator of FIG. 1. For MEMS interferometric modulators, the row/column (i.e., common/segment) write procedure may take advantage of a hysteresis property of these devices as illustrated in FIG. 3. An interferometric modulator may require, for example, about a 10-volt potential difference to cause the movable reflective layer, or mirror, to change from the relaxed state to the actuated state. When the voltage is reduced from that value, the movable reflective layer maintains its state as the voltage drops back below, e.g., 10 volts, however, the movable reflective layer does not relax completely until the voltage drops below 2 volts. Thus, a range of voltage, approximately 3 to 7 volts, as shown in FIG. 3, exists where there is a window of applied voltage within which the device is stable in either the relaxed or actuated state. This is referred to herein as the “hysteresis window” or “stability window.” For a display array 30 having the hysteresis characteristics of FIG. 3, the row/column write procedure can be designed to address one or more rows at a time, such that during the addressing of a given row, pixels in the addressed row that are to be actuated are exposed to a voltage difference of about 10 volts, and pixels that are to be relaxed are exposed to a voltage difference of near zero volts. After addressing, the pixels are exposed to a steady state or bias voltage difference of approximately 5-volts such that they remain in the previous strobing state. In this example, after being addressed, each pixel sees a potential difference within the “stability window” of about 3-7 volts. This hysteresis property feature enables the pixel design, e.g., illustrated in FIG. 1, to remain stable in either an actuated or relaxed pre-existing state under the same applied voltage conditions. Since each IMOD pixel, whether in the actuated or relaxed state, is essentially a capacitor formed by the fixed and moving reflective layers, this stable state can be held at a steady voltage within the hysteresis window without substantially consuming or losing power. Moreover, essentially little or no current flows into the IMOD pixel if the applied voltage potential remains substantially fixed.

In some implementations, a frame of an image may be created by applying data signals in the form of “segment” voltages along the set of column electrodes, in accordance with the desired change (if any) to the state of the pixels in a given row. Each row of the array can be addressed in turn, such that the frame is written one row at a time. To write the desired data to the pixels in a first row, segment voltages corresponding to the desired state of the pixels in the first row can be applied on the column electrodes, and a first row pulse in the form of a specific “common” voltage or signal can be applied to the first row electrode. The set of segment voltages can then be changed to correspond to the desired change (if any) to the state of the pixels in the second row, and a second common voltage can be applied to the second row electrode. In some implementations, the pixels in the first row are unaffected by the change in the segment voltages applied along the column electrodes, and remain in the state they were set to during the first common voltage row pulse. This process may be repeated for the entire series of rows, or alternatively, columns, in a sequential fashion to produce the image frame. The frames can be refreshed and/or updated with new image data by continually repeating this process at some desired number of frames per second.

The combination of segment and common signals applied across each pixel (that is, the potential difference across each pixel) determines the resulting state of each pixel. FIG. 4 shows an example of a table illustrating various states of an interferometric modulator when various common and segment voltages are applied. As will be readily understood by one having ordinary skill in the art, the “segment” voltages can be applied to either the column electrodes or the row electrodes, and the “common” voltages can be applied to the other of the column electrodes or the row electrodes.

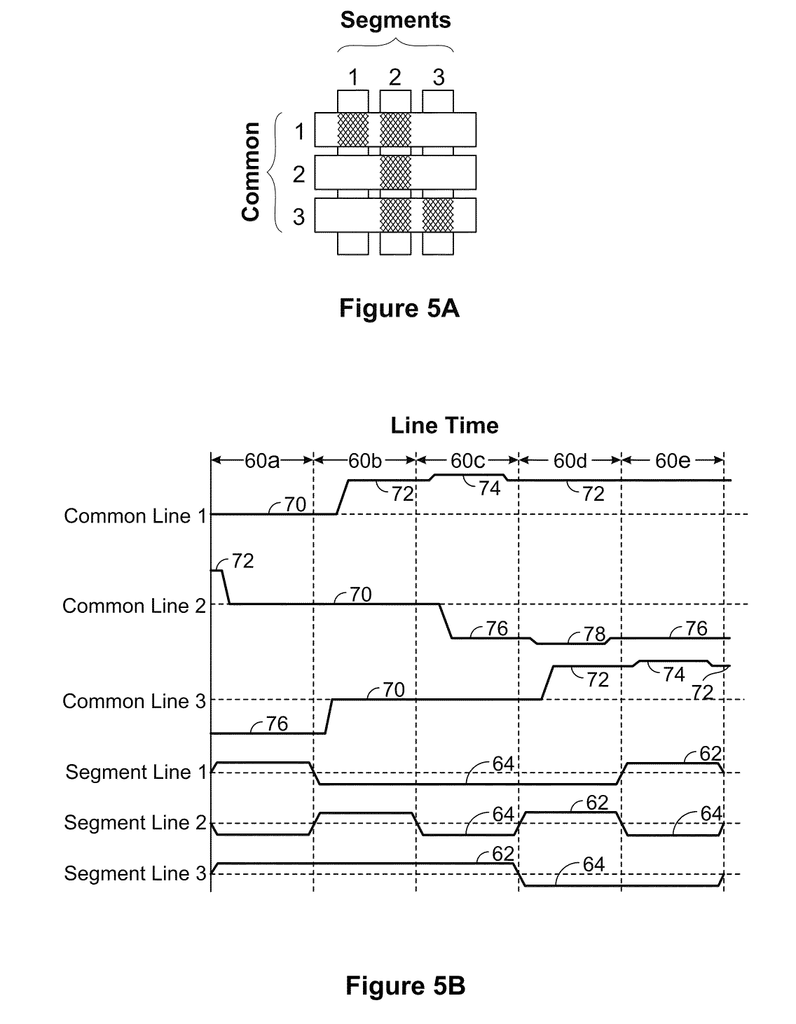

As illustrated in FIG. 4 (as well as in the timing diagram shown in FIG. 5B), when a release voltage VC_{REL} is applied along a common line, all interferometric modulator elements along the common line will be placed in a relaxed state, alternatively referred to as a released or unactuated state, regardless of the voltage applied along the segment lines, i.e., high segment voltage VS_{H} and low segment voltage VS_{L}. In particular, when the release voltage VC_{REL} is applied along a common line, the potential voltage across the modulator (alternatively referred to as a pixel voltage) is within the relaxation window (see FIG. 3, also referred to as a release window) both when the high segment voltage VS_{H} and the low segment voltage VS_{L} are applied along the corresponding segment line for that pixel.

When a hold voltage is applied on a common line, such as a high hold voltage VC_{HOLD}_{_{—}}_{H} or a low hold voltage VC_{HOLD}_{_{—}}_{L}, the state of the interferometric modulator will remain constant. For example, a relaxed IMOD will remain in a relaxed position, and an actuated IMOD will remain in an actuated position. The hold voltages can be selected such that the pixel voltage will remain within a stability window both when the high segment voltage VS_{H} and the low segment voltage VS_{L} are applied along the corresponding segment line. Thus, the segment voltage swing, i.e., the difference between the high VS_{H} and low segment voltage VS_{L}, is less than the width of either the positive or the negative stability window.

When an addressing, or actuation, voltage is applied on a common line, such as a high addressing voltage VC_{ADD}_{_{—}}_{H} or a low addressing voltage VC_{ADD}_{_{—}}_{L}, data can be selectively written to the modulators along that line by application of segment voltages along the respective segment lines. The segment voltages may be selected such that actuation is dependent upon the segment voltage applied. When an addressing voltage is applied along a common line, application of one segment voltage will result in a pixel voltage within a stability window, causing the pixel to remain unactuated. In contrast, application of the other segment voltage will result in a pixel voltage beyond the stability window, resulting in actuation of the pixel. The particular segment voltage which causes actuation can vary depending upon which addressing voltage is used. In some implementations, when the high addressing voltage VC_{ADD}_{_{—}}_{H} is applied along the common line, application of the high segment voltage VS_{H} can cause a modulator to remain in its current position, while application of the low segment voltage VS_{L} can cause actuation of the modulator. As a corollary, the effect of the segment voltages can be the opposite when a low addressing voltage VC_{ADD}_{_{—}}_{L} is applied, with high segment voltage VS_{H} causing actuation of the modulator, and low segment voltage VS_{L} having no effect (i.e., remaining stable) on the state of the modulator.

In some implementations, hold voltages, address voltages, and segment voltages may be used which always produce the same polarity potential difference across the modulators. In some other implementations, signals can be used which alternate the polarity of the potential difference of the modulators. Alternation of the polarity across the modulators (that is, alternation of the polarity of write procedures) may reduce or inhibit charge accumulation which could occur after repeated write operations of a single polarity.

FIG. 5A shows an example of a diagram illustrating a frame of display data in the 3×3 interferometric modulator display of FIG. 2. FIG. 5B shows an example of a timing diagram for common and segment signals that may be used to write the frame of display data illustrated in FIG. 5A. The signals can be applied to the, e.g., 3×3 array of FIG. 2, which will ultimately result in the line time 60e display arrangement illustrated in FIG. 5A. The actuated modulators in FIG. 5A are in a dark-state, i.e., where a substantial portion of the reflected light is outside of the visible spectrum so as to result in a dark appearance to, e.g., a viewer. Prior to writing the frame illustrated in FIG. 5A, the pixels can be in any state, but the write procedure illustrated in the timing diagram of FIG. 5B presumes that each modulator has been released and resides in an unactuated state before the first line time 60a.

During the first line time 60a, a release voltage 70 is applied on common line 1; the voltage applied on common line 2 begins at a high hold voltage 72 and moves to a release voltage 70; and a low hold voltage 76 is applied along common line 3. Thus, the modulators (common 1, segment 1), (1,2) and (1,3) along common line 1 remain in a relaxed, or unactuated, state for the duration of the first line time 60a, the modulators (2,1), (2,2) and (2,3) along common line 2 will move to a relaxed state, and the modulators (3,1), (3,2) and (3,3) along common line 3 will remain in their previous state. With reference to FIG. 4, the segment voltages applied along segment lines 1, 2 and 3 will have no effect on the state of the interferometric modulators, as none of common lines 1, 2 or 3 are being exposed to voltage levels causing actuation during line time 60a (i.e., VC_{REL}−relax and VC_{HOLD}_{_{—}}_{L}−stable).

During the second line time 60b, the voltage on common line 1 moves to a high hold voltage 72, and all modulators along common line 1 remain in a relaxed state regardless of the segment voltage applied because no addressing, or actuation, voltage was applied on the common line 1. The modulators along common line 2 remain in a relaxed state due to the application of the release voltage 70, and the modulators (3,1), (3,2) and (3,3) along common line 3 will relax when the voltage along common line 3 moves to a release voltage 70.

During the third line time 60c, common line 1 is addressed by applying a high address voltage 74 on common line 1. Because a low segment voltage 64 is applied along segment lines 1 and 2 during the application of this address voltage, the pixel voltage across modulators (1,1) and (1,2) is greater than the high end of the positive stability window (i.e., the voltage differential exceeded a predefined threshold) of the modulators, and the modulators (1,1) and (1,2) are actuated. Conversely, because a high segment voltage 62 is applied along segment line 3, the pixel voltage across modulator (1,3) is less than that of modulators (1,1) and (1,2), and remains within the positive stability window of the modulator; modulator (1,3) thus remains relaxed. Also during line time 60c, the voltage along common line 2 decreases to a low hold voltage 76, and the voltage along common line 3 remains at a release voltage 70, leaving the modulators along common lines 2 and 3 in a relaxed position.

During the fourth line time 60d, the voltage on common line 1 returns to a high hold voltage 72, leaving the modulators along common line 1 in their respective addressed states. The voltage on common line 2 is decreased to a low address voltage 78. Because a high segment voltage 62 is applied along segment line 2, the pixel voltage across modulator (2,2) is below the lower end of the negative stability window of the modulator, causing the modulator (2,2) to actuate. Conversely, because a low segment voltage 64 is applied along segment lines 1 and 3, the modulators (2,1) and (2,3) remain in a relaxed position. The voltage on common line 3 increases to a high hold voltage 72, leaving the modulators along common line 3 in a relaxed state.

Finally, during the fifth line time 60e, the voltage on common line 1 remains at high hold voltage 72, and the voltage on common line 2 remains at a low hold voltage 76, leaving the modulators along common lines 1 and 2 in their respective addressed states. The voltage on common line 3 increases to a high address voltage 74 to address the modulators along common line 3. As a low segment voltage 64 is applied on segment lines 2 and 3, the modulators (3,2) and (3,3) actuate, while the high segment voltage 62 applied along segment line 1 causes modulator (3,1) to remain in a relaxed position. Thus, at the end of the fifth line time 60e, the 3×3 pixel array is in the state shown in FIG. 5A, and will remain in that state as long as the hold voltages are applied along the common lines, regardless of variations in the segment voltage which may occur when modulators along other common lines (not shown) are being addressed.

In the timing diagram of FIG. 5B, a given write procedure (i.e., line times 60a-60e) can include the use of either high hold and address voltages, or low hold and address voltages. Once the write procedure has been completed for a given common line (and the common voltage is set to the hold voltage having the same polarity as the actuation voltage), the pixel voltage remains within a given stability window, and does not pass through the relaxation window until a release voltage is applied on that common line. Furthermore, as each modulator is released as part of the write procedure prior to addressing the modulator, the actuation time of a modulator, rather than the release time, may determine the necessary line time. Specifically, in implementations in which the release time of a modulator is greater than the actuation time, the release voltage may be applied for longer than a single line time, as depicted in FIG. 5B. In some other implementations, voltages applied along common lines or segment lines may vary to account for variations in the actuation and release voltages of different modulators, such as modulators of different colors.

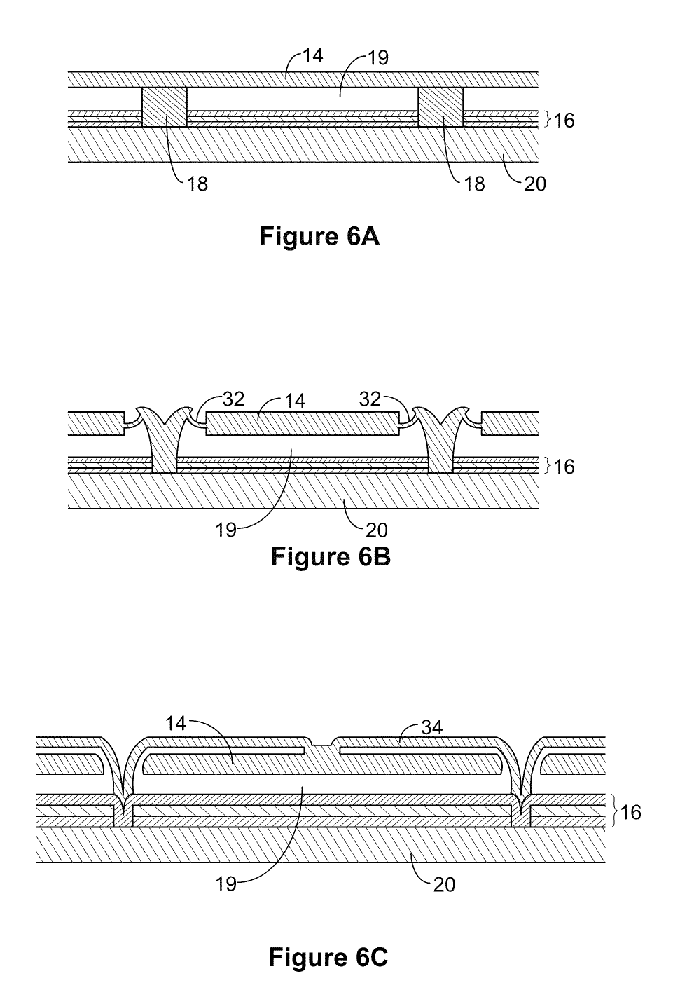

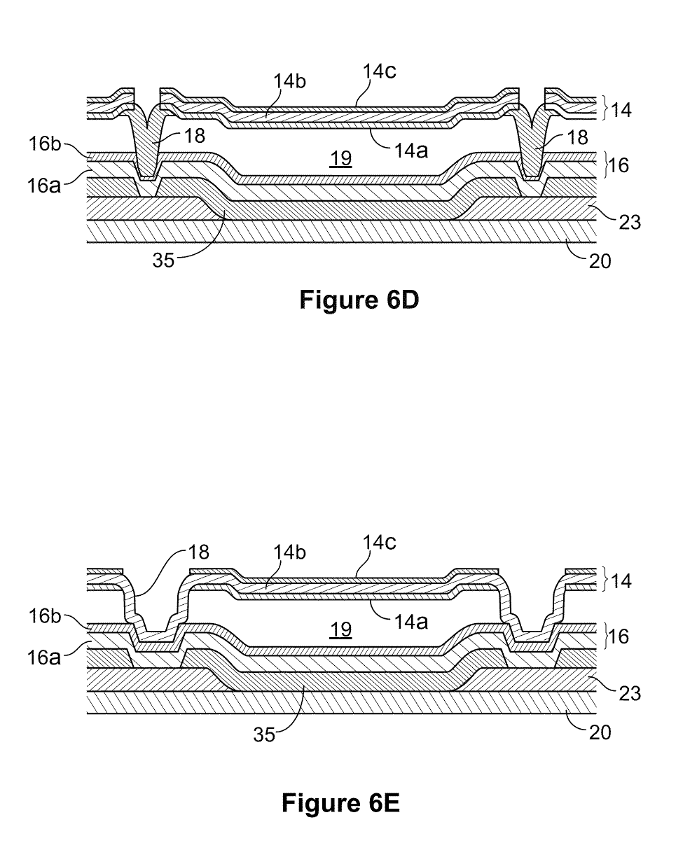

The details of the structure of interferometric modulators that operate in accordance with the principles set forth above may vary widely. For example, FIGS. 6A-6E show examples of cross-sections of varying implementations of interferometric modulators, including the movable reflective layer 14 and its supporting structures. FIG. 6A shows an example of a partial cross-section of the interferometric modulator display of FIG. 1, where a strip of metal material, i.e., the movable reflective layer 14 is deposited on supports 18 extending orthogonally from the substrate 20. In FIG. 6B, the movable reflective layer 14 of each IMOD is generally square or rectangular in shape and attached to supports at or near the corners, on tethers 32. In FIG. 6C, the movable reflective layer 14 is generally square or rectangular in shape and suspended from a deformable layer 34, which may include a flexible metal. The deformable layer 34 can connect, directly or indirectly, to the substrate 20 around the perimeter of the movable reflective layer 14. These connections are herein referred to as support posts. The implementation shown in FIG. 6C has additional benefits deriving from the decoupling of the optical functions of the movable reflective layer 14 from its mechanical functions, which are carried out by the deformable layer 34. This decoupling allows the structural design and materials used for the reflective layer 14 and those used for the deformable layer 34 to be optimized independently of one another.

FIG. 6D shows another example of an IMOD, where the movable reflective layer 14 includes a reflective sub-layer 14a. The movable reflective layer 14 rests on a support structure, such as support posts 18. The support posts 18 provide separation of the movable reflective layer 14 from the lower stationary electrode (i.e., part of the optical stack 16 in the illustrated IMOD) so that a gap 19 is formed between the movable reflective layer 14 and the optical stack 16, for example when the movable reflective layer 14 is in a relaxed position. The movable reflective layer 14 also can include a conductive layer 14c, which may be configured to serve as an electrode, and a support layer 14b. In this example, the conductive layer 14c is disposed on one side of the support layer 14b, distal from the substrate 20, and the reflective sub-layer 14a is disposed on the other side of the support layer 14b, proximal to the substrate 20. In some implementations, the reflective sub-layer 14a can be conductive and can be disposed between the support layer 14b and the optical stack 16. The support layer 14b can include one or more layers of a dielectric material, for example, silicon oxynitride (SiON) or silicon dioxide (SiO₂). In some implementations, the support layer 14b can be a stack of layers, such as, for example, an SiO₂/SiON/SiO₂ tri-layer stack. Either or both of the reflective sub-layer 14a and the conductive layer 14c can include, e.g., an Al alloy with about 0.5% Cu, or another reflective metallic material. Employing conductive layers 14a, 14c above and below the dielectric support layer 14b can balance stresses and provide enhanced conduction. In some implementations, the reflective sub-layer 14a and the conductive layer 14c can be formed of different materials for a variety of design purposes, such as achieving specific stress profiles within the movable reflective layer 14.

As illustrated in FIG. 6D, some implementations also can include a black mask structure 23. The black mask structure 23 can be formed in optically inactive regions (e.g., between pixels or under posts 18) to absorb ambient or stray light. The black mask structure 23 also can improve the optical properties of a display device by inhibiting light from being reflected from or transmitted through inactive portions of the display, thereby increasing the contrast ratio. Additionally, the black mask structure 23 can be conductive and be configured to function as an electrical bussing layer. In some implementations, the row electrodes can be connected to the black mask structure 23 to reduce the resistance of the connected row electrode. The black mask structure 23 can be formed using a variety of methods, including deposition and patterning techniques. The black mask structure 23 can include one or more layers. For example, in some implementations, the black mask structure 23 includes a molybdenum-chromium (MoCr) layer that serves as an optical absorber, an SiO₂ layer, and an aluminum alloy that serves as a reflector and a bussing layer, with a thickness in the range of about 30-80 Å, 500-1000 Å, and 500-6000 Å, respectively. The one or more layers can be patterned using a variety of techniques, including photolithography and dry etching, including, for example, CF₄ and/or O₂ for the MoCr and SiO₂ layers and Cl₂ and/or BCl₃ for the aluminum alloy layer. In some implementations, the black mask 23 can be an etalon or interferometric stack structure. In such interferometric stack black mask structures 23, the conductive absorbers can be used to transmit or bus signals between lower, stationary electrodes in the optical stack 16 of each row or column. In some implementations, a spacer layer 35 can serve to generally electrically isolate the absorber layer 16a from the conductive layers in the black mask 23.

FIG. 6E shows another example of an IMOD, where the movable reflective layer 14 is self-supporting. In contrast with FIG. 6D, the implementation of FIG. 6E does not include support posts 18. Instead, the movable reflective layer 14 contacts the underlying optical stack 16 at multiple locations, and the curvature of the movable reflective layer 14 provides sufficient support that the movable reflective layer 14 returns to the unactuated position of FIG. 6E when the voltage across the interferometric modulator is insufficient to cause actuation. The optical stack 16, which may contain a plurality of several different layers, is shown here for clarity including an optical absorber 16a, and a dielectric 16b. In some implementations, the optical absorber 16a may serve both as a fixed electrode and as a partially reflective layer.

In implementations such as those shown in FIGS. 6A-6E, the IMODs function as direct-view devices, in which images are viewed from the front side of the transparent substrate 20, i.e., the side opposite to that upon which the modulator is arranged. In these implementations, the back portions of the device (that is, any portion of the display device behind the movable reflective layer 14, including, for example, the deformable layer 34 illustrated in FIG. 6C) can be configured and operated upon without impacting or negatively affecting the image quality of the display device, because the reflective layer 14 optically shields those portions of the device. For example, in some implementations a bus structure (not illustrated) can be included behind the movable reflective layer 14 which provides the ability to separate the optical properties of the modulator from the electromechanical properties of the modulator, such as voltage addressing and the movements that result from such addressing. Additionally, the implementations of FIGS. 6A-6E can simplify processing, such as, e.g., patterning.

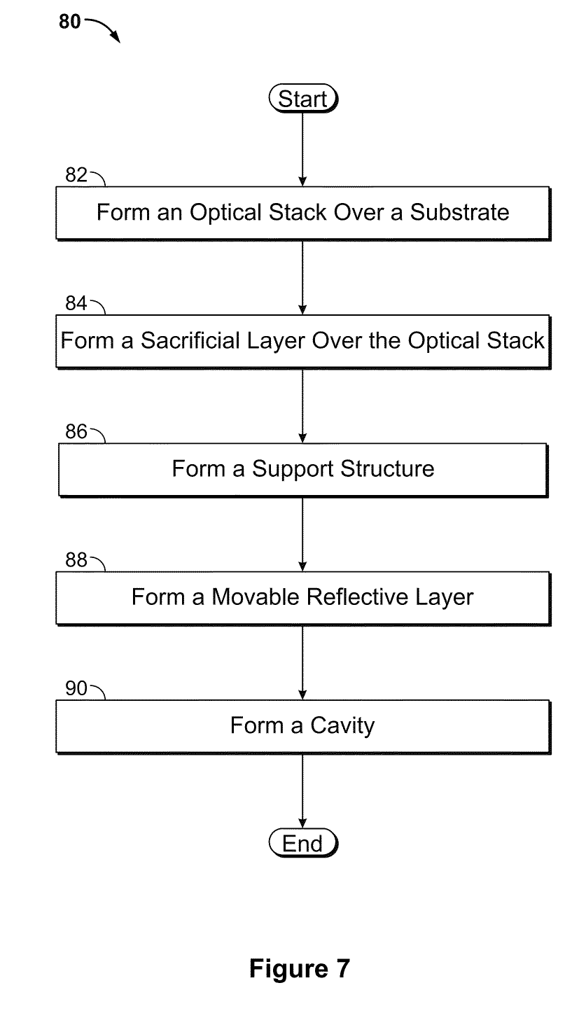

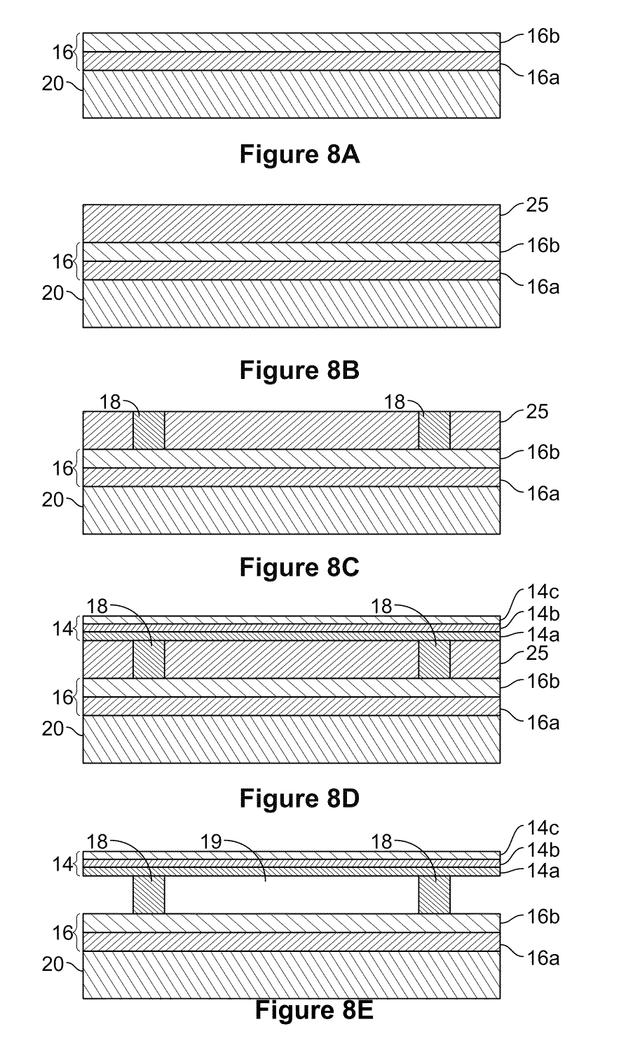

FIG. 7 shows an example of a flow diagram illustrating a manufacturing process 80 for an interferometric modulator, and FIGS. 8A-8E show examples of cross-sectional schematic illustrations of corresponding stages of such a manufacturing process 80. In some implementations, the manufacturing process 80 can be implemented to manufacture, e.g., interferometric modulators of the general type illustrated in FIGS. 1 and 6, in addition to other blocks not shown in FIG. 7. With reference to FIGS. 1, 6 and 7, the process 80 begins at block 82 with the formation of the optical stack 16 over the substrate 20. FIG. 8A illustrates such an optical stack 16 formed over the substrate 20. The substrate 20 may be a transparent substrate such as glass or plastic, it may be flexible or relatively stiff and unbending, and may have been subjected to prior preparation processes, e.g., cleaning, to facilitate efficient formation of the optical stack 16. As discussed above, the optical stack 16 can be electrically conductive, partially transparent and partially reflective and may be fabricated, for example, by depositing one or more layers having the desired properties onto the transparent substrate 20. In FIG. 8A, the optical stack 16 includes a multilayer structure having sub-layers 16a and 16b, although more or fewer sub-layers may be included in some other implementations. In some implementations, one of the sub-layers 16a, 16b can be configured with both optically absorptive and conductive properties, such as the combined conductor/absorber sub-layer 16a. Additionally, one or more of the sub-layers 16a, 16b can be patterned into parallel strips, and may form row electrodes in a display device. Such patterning can be performed by a masking and etching process or another suitable process known in the art. In some implementations, one of the sub-layers 16a, 16b can be an insulating or dielectric layer, such as sub-layer 16b that is deposited over one or more metal layers (e.g., one or more reflective and/or conductive layers). In addition, the optical stack 16 can be patterned into individual and parallel strips that form the rows of the display.

The process 80 continues at block 84 with the formation of a sacrificial layer 25 over the optical stack 16. The sacrificial layer 25 is later removed (e.g., at block 90) to form the cavity 19 and thus the sacrificial layer 25 is not shown in the resulting interferometric modulators 12 illustrated in FIG. 1. FIG. 8B illustrates a partially fabricated device including a sacrificial layer 25 formed over the optical stack 16. The formation of the sacrificial layer 25 over the optical stack 16 may include deposition of a xenon difluoride (XeF₂)-etchable material such as molybdenum (Mo) or amorphous silicon (Si), in a thickness selected to provide, after subsequent removal, a gap or cavity 19 (see also FIGS. 1 and 8E) having a desired design size. Deposition of the sacrificial material may be carried out using deposition techniques such as physical vapor deposition (PVD, e.g., sputtering), plasma-enhanced chemical vapor deposition (PECVD), thermal chemical vapor deposition (thermal CVD), or spin-coating.

The process 80 continues at block 86 with the formation of a support structure e.g., a post 18 as illustrated in FIGS. 1, 6 and 8C. The formation of the post 18 may include patterning the sacrificial layer 25 to form a support structure aperture, then depositing a material (e.g., a polymer or an inorganic material, e.g., silicon oxide) into the aperture to form the post 18, using a deposition method such as PVD, PECVD, thermal CVD, or spin-coating. In some implementations, the support structure aperture formed in the sacrificial layer can extend through both the sacrificial layer 25 and the optical stack 16 to the underlying substrate 20, so that the lower end of the post 18 contacts the substrate 20 as illustrated in FIG. 6A. Alternatively, as depicted in FIG. 8C, the aperture formed in the sacrificial layer 25 can extend through the sacrificial layer 25, but not through the optical stack 16. For example, FIG. 8E illustrates the lower ends of the support posts 18 in contact with an upper surface of the optical stack 16. The post 18, or other support structures, may be formed by depositing a layer of support structure material over the sacrificial layer 25 and patterning portions of the support structure material located away from apertures in the sacrificial layer 25. The support structures may be located within the apertures, as illustrated in FIG. 8C, but also can, at least partially, extend over a portion of the sacrificial layer 25. As noted above, the patterning of the sacrificial layer 25 and/or the support posts 18 can be performed by a patterning and etching process, but also may be performed by alternative etching methods.

The process 80 continues at block 88 with the formation of a movable reflective layer or membrane such as the movable reflective layer 14 illustrated in FIGS. 1, 6 and 8D. The movable reflective layer 14 may be formed by employing one or more deposition processes, e.g., reflective layer (e.g., aluminum, aluminum alloy) deposition, along with one or more patterning, masking, and/or etching processes. The movable reflective layer 14 can be electrically conductive, and referred to as an electrically conductive layer. In some implementations, the movable reflective layer 14 may include a plurality of sub-layers 14a, 14b, 14c as shown in FIG. 8D. In some implementations, one or more of the sub-layers, such as sub-layers 14a, 14c, may include highly reflective sub-layers selected for their optical properties, and another sub-layer 14b may include a mechanical sub-layer selected for its mechanical properties. Since the sacrificial layer 25 is still present in the partially fabricated interferometric modulator formed at block 88, the movable reflective layer 14 is typically not movable at this stage. A partially fabricated IMOD that contains a sacrificial layer 25 may also be referred to herein as an “unreleased” IMOD. As described above in connection with FIG. 1, the movable reflective layer 14 can be patterned into individual and parallel strips that form the columns of the display.

The process 80 continues at block 90 with the formation of a cavity, e.g., cavity 19 as illustrated in FIGS. 1, 6 and 8E. The cavity 19 may be formed by exposing the sacrificial material 25 (deposited at block 84) to an etchant. For example, an etchable sacrificial material such as Mo or amorphous Si may be removed by dry chemical etching, e.g., by exposing the sacrificial layer 25 to a gaseous or vaporous etchant, such as vapors derived from solid XeF₂ for a period of time that is effective to remove the desired amount of material, typically selectively removed relative to the structures surrounding the cavity 19. Other combinations of etchable sacrificial material and etching methods, e.g. wet etching and/or plasma etching, also may be used. Since the sacrificial layer 25 is removed during block 90, the movable reflective layer 14 is typically movable after this stage. After removal of the sacrificial material 25, the resulting fully or partially fabricated IMOD may be referred to herein as a “released” IMOD.

IMOD display devices or display panels are relatively unique among the various types of display devices or display panels used in most modern electronic devices in that IMODs, unlike, for example, LCD pixels, feature mechanical parts that move when an IMOD experiences a state change, e.g., changing from a “bright” state to a “dark” state or vice versa. When the mechanical element or elements of an IMOD move, acoustic artifacts, e.g., “clicks,” may be produced that may be detectable by a suitably sensitive acoustic or vibrational detector. When multiple IMODs change state simultaneously or near-simultaneously, the resulting acoustic artifacts may blend into one another to produce a larger acoustic artifact or a series of acoustic artifacts, e.g., a coded pattern, that may be detectable using less sensitive equipment. It is to be understood that, in the context of this application, the absence of an acoustic artifact at particular times may also be viewed as an acoustic artifact, i.e., when reference is made to detecting acoustic artifacts or processing acoustic artifacts, such reference is intended to also include non-detection of any acoustic artifacts at a time when an acoustic artifact might otherwise be expected.

While the examples discussed herein involve scenarios where IMODs produce substantially similar acoustic artifacts when experiencing any state change, in actual practice, IMODs may produce acoustic artifacts of different magnitudes depending on the nature of the state change experienced. For example, an IMOD experiencing a state change from the dark state to the bright state may produce an acoustic artifact that is much larger in magnitude than the same IMOD may produce when changing state from the bright state to the dark state. In some implementations, the magnitude difference may be so pronounced that one type of state change is largely undetectable by the sensors used. The techniques outlined herein may still be used with such IMODs, but with appropriate modification.

If every IMOD in an IMOD display panel is driven to change states simultaneously, the resulting acoustic artifacts may be very audible even to the naked ear. The power requirements needed, however, to drive all of the IMODs in a typical IMOD display panel simultaneously may be impractical in the context of most consumer devices. As a compromise, a typical IMOD display panel controller may be configured to address and actuate IMODs by row, scanning through the rows at a high refresh rate. Thus, at any given time, only the IMODs in one row of IMODs may need to be provided with power to affect a state change, significantly reducing the overall power needs of the IMOD display panel. In some implementations, further power savings may be realized by then individually scanning through each IMOD in a given row and individually actuating the IMODs as necessary. The scan frequency of such IMOD display controllers may be quite high, e.g., a row-scan frequency of 15-30 kHz, in order to present overall changes in graphical content across the entirety of an IMOD display panel at a sufficiently high refresh rate that a human observer will be presented with graphical content that appears to be smooth and continuous, e.g., with an overall frame rate in the 15 to 60 Hz range. Other scan frequencies and overall frame rates may be supported as well.

The row scan frequency for a particular IMOD display may be calculated by multiplying the desired display frame rate by the number of rows of pixels that are in the IMOD display. For example, to achieve a 15 Hz display frame rate using a 768 row display, the row scan frequency will need to be approximately 11.5 kHz. However, various factors can change this value. For example, if the IMOD is a color display with, for example, red, blue, and green sub-pixels for each pixel, this will effectively triple the number of rows in the display and result in the row scan frequency increasing to approximately 34.5 kHz. A row scan frequency of such magnitude, however, may be difficult to support within the specifications of the display panel. One way to address this issue is to split the IMOD display panel in half and drive half of the IMOD display panel using one controller and drive the other half in parallel with another controller. Such an implementation allows for the row scan frequency for the above example to be halved to approximately 17 kHz.

In the case of an IMOD display panel in which the IMODs are all driven simultaneously or near-simultaneously, the acoustic artifacts from display panel state change may occur substantially simultaneously, giving rise to a single detectable acoustic event with a magnitude dependent on the total number of IMODs that change state. Thus, such an IMOD drive scheme would generally only produce a single data point describing the state change associated with transitioning the IMOD display panel from displaying one piece of graphical content to another.

For many typical IMOD display panels, however, the IMODs are not all actuated simultaneously and are, instead, actuated in series, either individually or in groups, e.g., rows or columns, as discussed above. For example, the IMODs in each column of IMODs in a 128×96 pixel IMOD display panel may be actuated in series, resulting in 128 separate column actuation groupings. A different number of IMODs may change state within each column actuation grouping. Thus, each column grouping may produce a different number of acoustic artifacts and produce a different magnitude of overall acoustic artifact. In a scenario where the acoustic artifacts produced by each IMOD are identical in magnitude and the acoustic or vibrational sensor is sensitive enough to determine the exact number of acoustic artifacts produced as a result of each column grouping actuation, the acoustic artifact data recorded from actuating IMODs in the example 128×96 pixel IMOD display panel could represent a set of 128 values, each value ranging from between 0 and 96 (97 distinct values), i.e., 97¹²⁸≈200×10²⁵² unique values. It is to be noted that while there are only 96 IMODs per column in this example, there are potentially 97 different levels of IMOD actuations per column because of the “zero” actuation state where no IMODs change state.

In practical terms, there may be limits on the precision with which acoustic artifacts may be measured. One such limit may be that the acoustic sensor used may not have sufficient granularity to distinguish between the finest levels of acoustic artifact magnitude. For example, an acoustic sensor used with the example 128×96 pixel display may only be able to accurately differentiate between about 10 different magnitudes of acoustic artifacts associated with IMOD state changes for each column grouping. Thus, the resulting set of 128 different magnitudes may only represent 10¹²⁸ different acoustic artifact dataset values.

Another limit on the precision with which acoustic artifacts may be measured is the variation in magnitude between acoustic artifacts produced by IMODs in an IMOD display. For example, if there is a potential for +/−10% variation in acoustic artifact magnitude between individual IMOD elements, this may mean that the range of reliably-detectable acoustic artifact magnitudes is considerably smaller than in the ideal case. However, while the use of acoustic artifact data obtained from measuring acoustic artifacts produced by IMODs may be somewhat limited by various practical concerns, the acoustic artifact data may still provide a substantial amount of usable information.

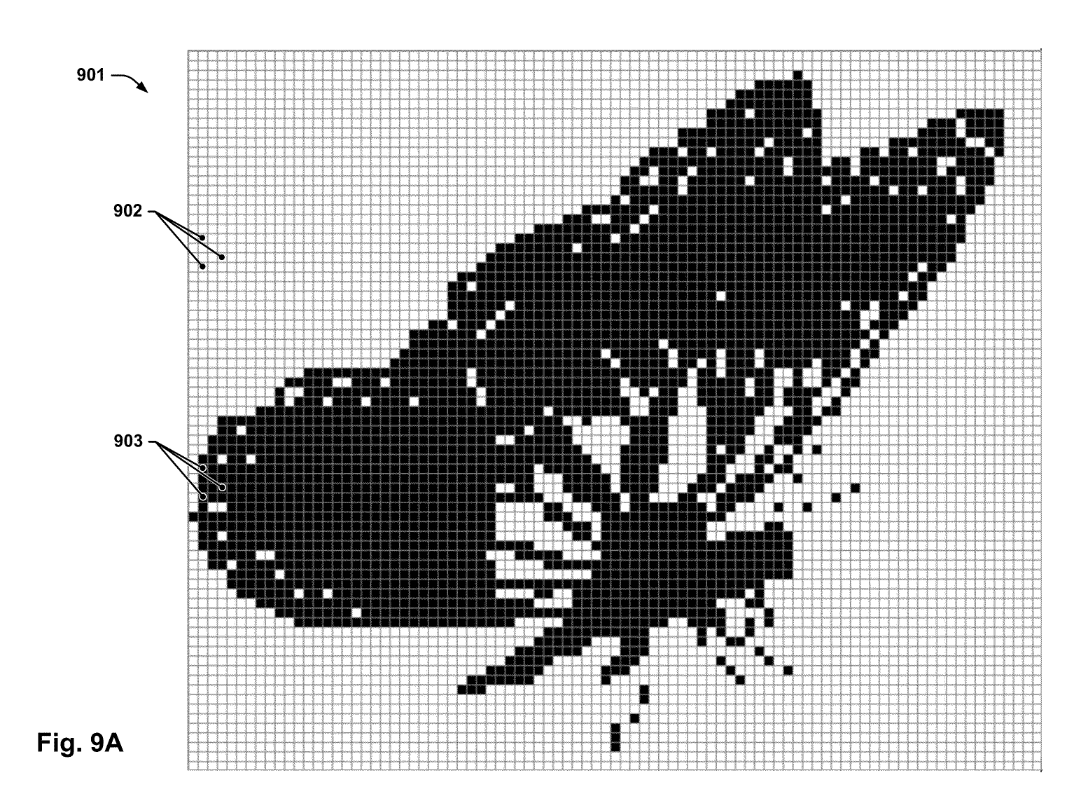

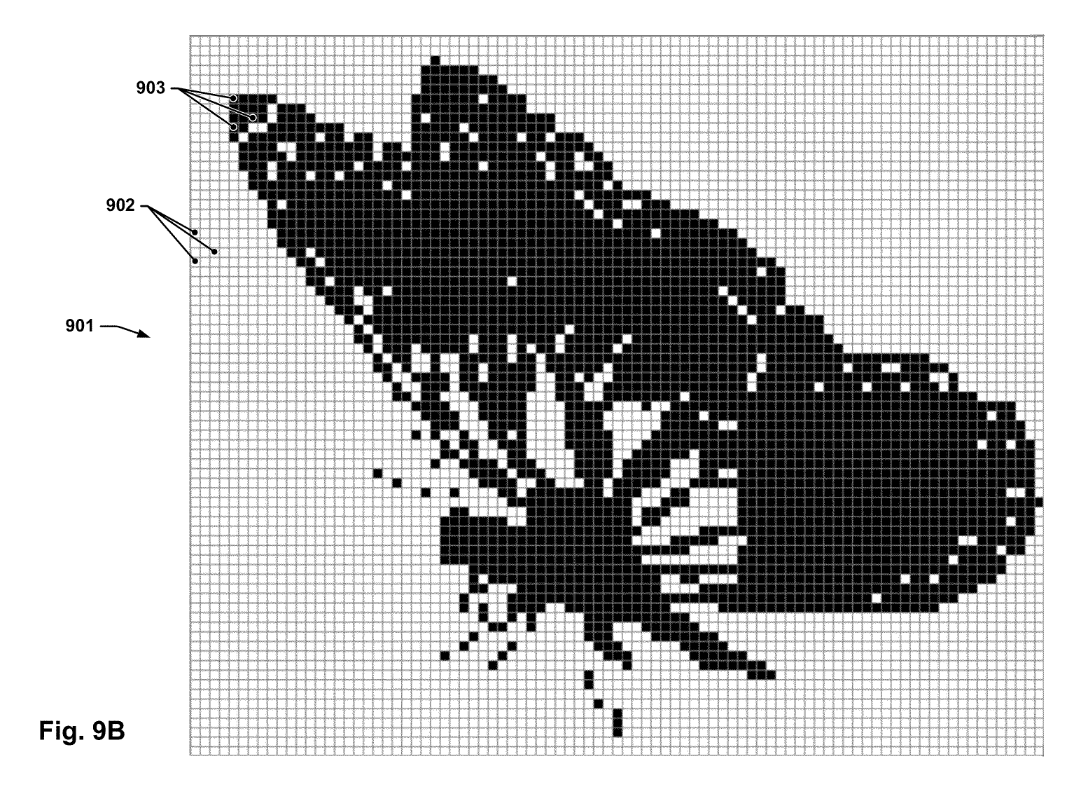

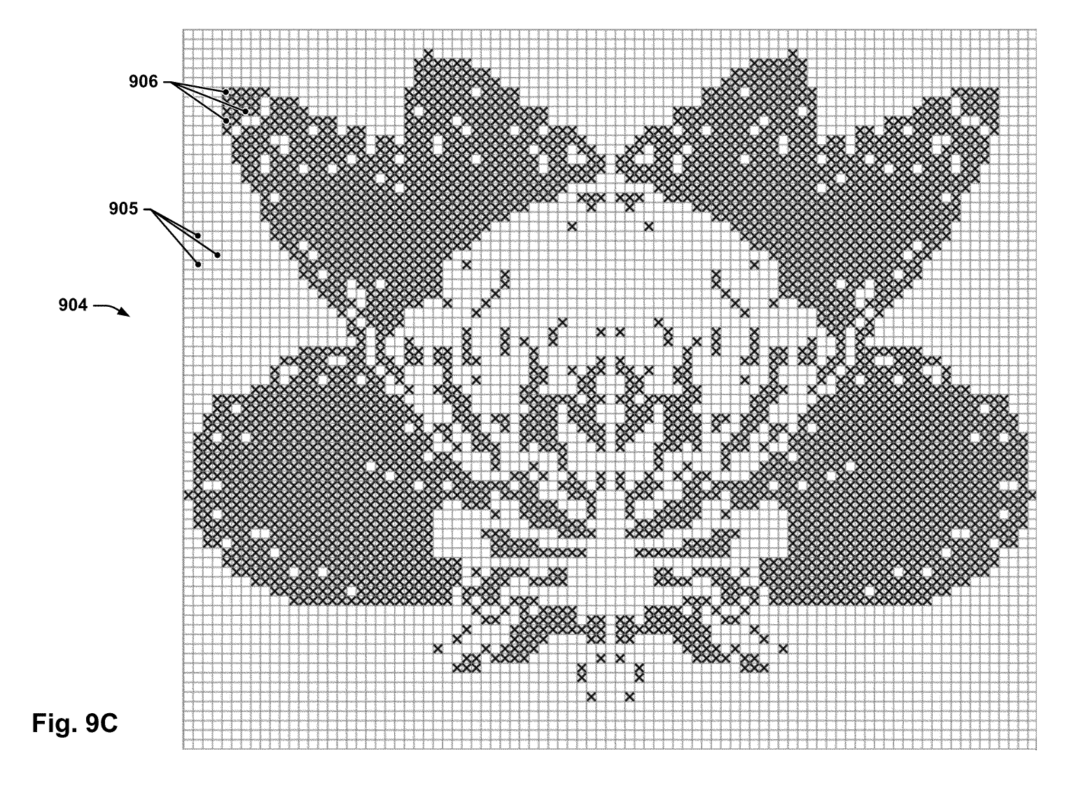

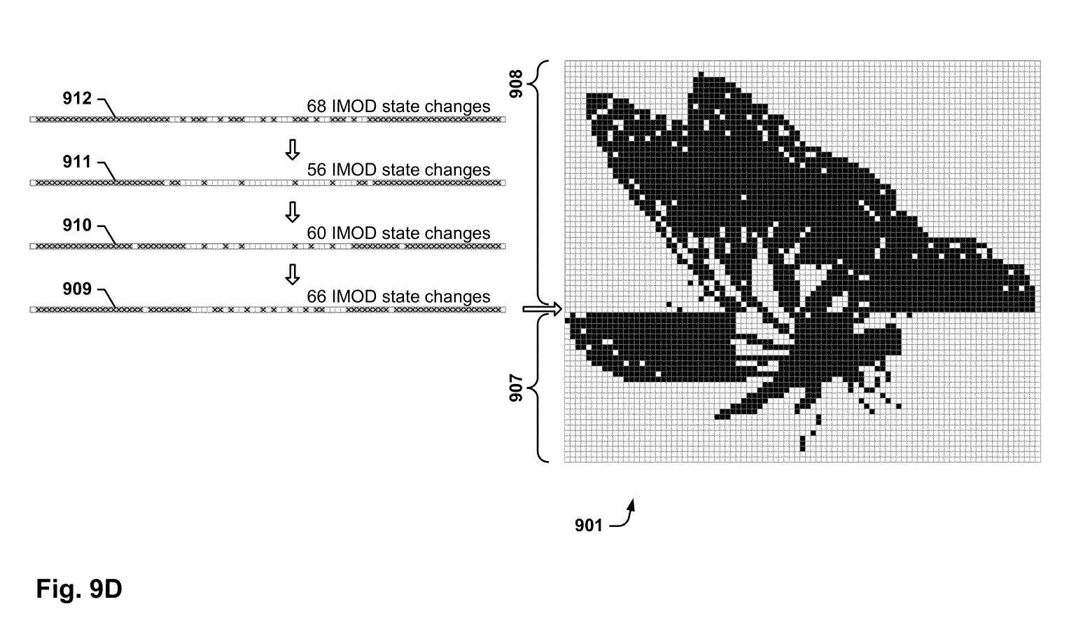

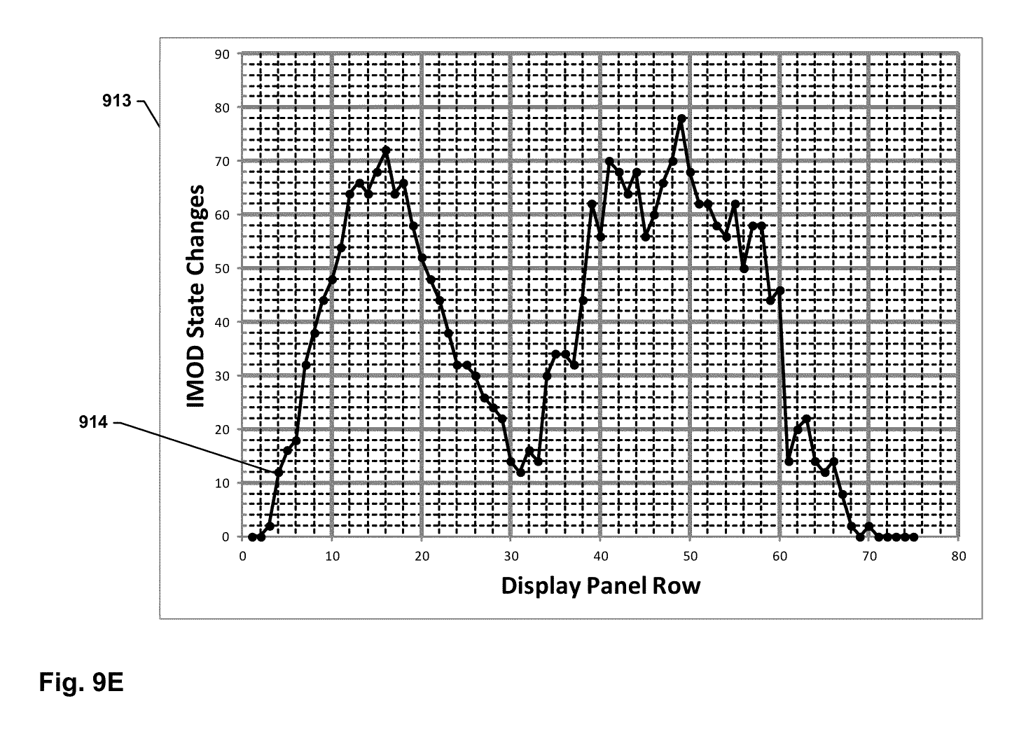

For example, in some implementations, acoustic artifact data may be used to “fingerprint,” authenticate, or otherwise uniquely (or near-uniquely) identify a piece of graphical content. Reference is made to FIGS. 9A to 9E to illustrate this concept.

FIG. 9A shows an example of graphical content that may be displayed using an IMOD display panel. In this example, an IMOD display panel 901 is used that is 99×75 pixels in size and that is a black and white display. The IMOD display panel 901 may include bright pixels 902 and dark pixels 903. The graphical content displayed is a black-and-white image of a butterfly. In order to “fingerprint” a subject graphic such as that shown in FIG. 9A using acoustic artifact data, it may be necessary to transition between the subject graphic and a known, reference graphic. This transition may be from the subject graphic to the reference graphic or vice versa. This is because the acoustic artifacts that are used to fingerprint the subject graphic are produced by state changes resulting from the transition to or from the subject graphic on the IMOD display panel. As such, it may be necessary to designate a reference graphic and then evaluate the acoustic artifacts produced when transitioning the IMOD display panel from displaying the reference graphic to displaying the subject graphic (or vice versa). A variety of reference graphics may be used—they may be static reference patterns, or produced as a result of an algorithm.

One potential reference graphic that may be used is shown in FIG. 9B. FIG. 9B shows the example of graphical content of FIG. 9A, but mirrored across a vertical axis. Thus, any given subject graphic may also serve as its own reference graphic, subject to certain manipulations, e.g., mirroring across a horizontal, vertical, or other axis; lateral or vertical image shift; image rotation; etc. In this example, the butterfly has been mirrored about the vertical axis and is now facing the right side of the IMOD display panel 901.

FIG. 9C shows an example state change map for an example IMOD display panel that illustrates the pixels that would need to change state in the example IMOD display panel of FIGS. 9A and 9B between displaying the subject graphic of FIG. 9A and displaying the reference graphic of FIG. 9B. State change map 904 uses squares with an “X” in them to represent pixels having state changes, i.e., IMODs, that changed state in the transition from the butterfly image to the mirrored butterfly image. As can be seen, IMODs 905 that have the same display state in both images, e.g., that are “dark” in both images or “bright” in both images, do not need to change state and are not marked as changing state. IMODs 906 that are in different states between the two images, however, do need to change state and are marked as experiencing a state change in FIG. 9C.

FIG. 9D shows an example of several raster scan lines of IMOD state changes for the example IMOD display panel of FIG. 9C transitioning from displaying the reference graphic of FIG. 9B to displaying the subject graphic of FIG. 9A. As can be seen, FIG. 9D shows the IMOD display panel slightly less than halfway through the transition from displaying the leftwards-facing butterfly image of the reference graphic to displaying the subject graphic of the rightwards-facing butterfly image. Thus, the IMODs in the rows in the upper portion 908 of the IMOD display panel have yet to undergo the state changes that are needed to transition from the rightwards-facing image to the leftwards-facing image, and the IMODs in the rows in the lower portion 907 of the IMOD display panel have already experienced the state changes that are needed to accomplish the transition.

Also shown in FIG. 9D are four state change maps for the next four rows of IMODs that will be actuated (rows 19-22 from the bottom). As can be seen, there will be 66 IMOD state changes when the 19^{th} row 909 is actuated, 60 IMOD state changes when the 20^{th} row 910 is actuated, 56 IMOD state changes when the 21^{st} row 911 is actuated, and 68 IMOD state changes when the 22^{nd} row 912 is actuated. By detecting the number or overall magnitude of acoustic artifacts produced as a result of each row's IMOD actuations, the number of IMOD state changes associated with each row actuation may be determined or estimated.

FIG. 9E shows an example plot of IMOD state changes versus IMOD row for the example state change map of FIG. 9C. As can be seen, the number of IMOD state changes that occurs in each row plotted as a function of row location reveals a particular profile 914 for the butterfly image of interest. Thus, the profile 914 shown in graph 913 may serve as the basis for a “fingerprint” of the image.

If additional detail is needed in an image fingerprint, the process may be repeated with one or more additional patterns. For example, the image could be flipped about another axis and the acoustic artifacts detected and analyzed. The resulting additional profile data may be added to the preexisting profile data to produce a longer, more unique profile.

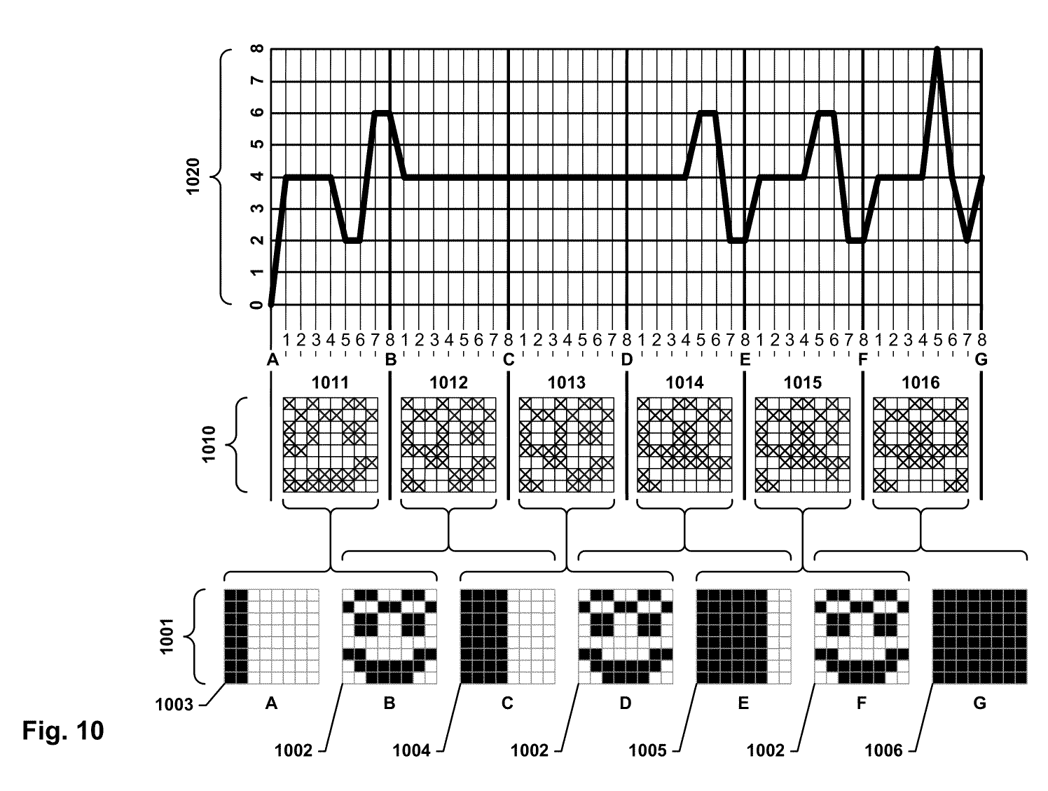

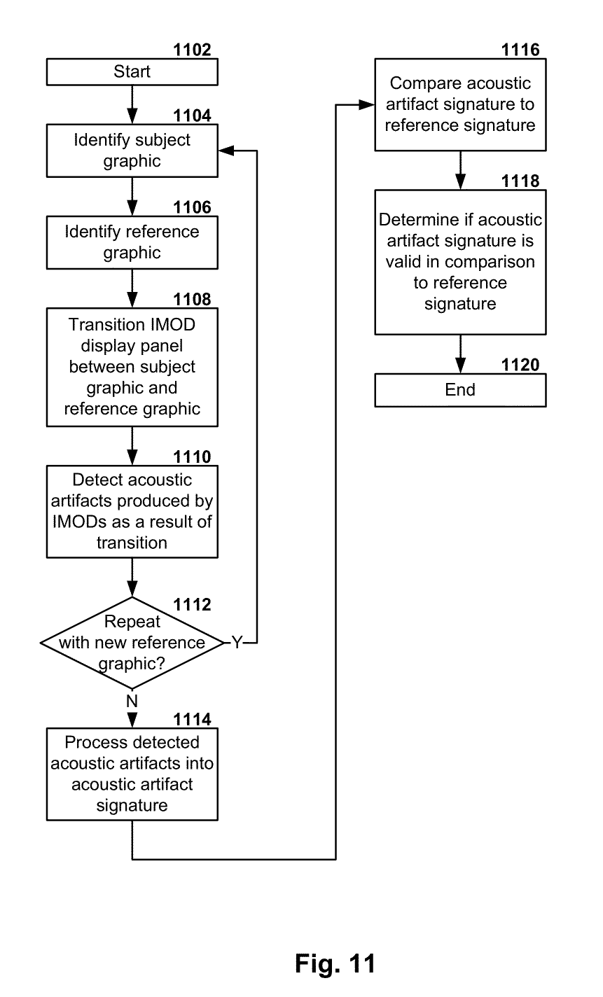

FIG. 10 shows a plot of state changes that may occur in an example IMOD display panel when the example IMOD display panel is transitioned between a subject graphic and a series of reference images, as well as the subject graphic, reference graphics, and state change maps for transitioning between the subject graphic and reference graphics. In FIG. 10, various graphics 1001 are shown on an 8×8 pixel IMOD display panel, including a subject graphic 1002. The subject graphic 1002, in this example, is a simple rendition of a “smiley face.” The subject graphic 1002 may be displayed before and/or after a reference graphic. In this example, four different reference graphics are used: a first reference graphic 1003, a second reference graphic 1004, a third reference graphic 1005, and a fourth reference graphic 1006. The reference graphics in this example are relatively simple, each including a progressively larger rectangular block of dark pixels. Thus, the first reference graphic 1003 includes a 2×8 column of dark pixels along the left edge of the reference graphic, the remaining pixels being bright pixels. The second reference graphic 1004 includes a 4×8 block of dark pixels on the left side, and a 4×8 block of bright pixels on the right side. The third reference graphic 1005 includes a 6×8 pixel block of dark pixels on the left side, and a 2×8 block of bright pixels on the right side. The fourth reference graphic 1006 is a graphic of only dark pixels.

The subject graphic 1002 may be displayed between each of the reference graphics 1003-1006. Thus, as shown in FIG. 10, a total of seven images are displayed in this example: the first reference graphic 1003, the subject graphic 1002, the second reference graphic 1004, the subject graphic 1002, the third reference graphic 1005, the subject graphic 1002, and then the fourth reference graphic 1006.

Between each display of a reference graphic and the subject graphic 1002, the IMOD display panel may undergo state changes in order to transition between the subject graphic 1002 and one of the reference graphics. State change maps 1010, similar to the state change map 904 in FIG. 9C, indicate the nature of the state changes experienced.

For example, state change map 1011 represents the IMOD state changes necessary to transition the IMOD display panel from displaying the first reference graphic 1003 to displaying the subject graphic 1002. As in FIG. 9C, pixels marked with an “X” represent IMODs that undergo a state change. State change map 1012 represents the IMOD state changes necessary to transition the IMOD display panel from displaying the subject graphic 1002 to displaying the second reference graphic 1004. State change map 1013 represents the IMOD state changes necessary to transition the IMOD display panel from displaying the second reference graphic 1004 to displaying the subject graphic 1002. State change map 1014 represents the IMOD state changes necessary to transition the IMOD display panel from displaying the subject graphic 1002 to displaying the third reference graphic 1005. State change map 1015 represents the IMOD state changes necessary to transition the IMOD display panel from displaying the third reference graphic 1005 to displaying the subject graphic 1002. Finally, state change map 1016 represents the IMOD state changes necessary to transition the IMOD display panel from displaying the subject graphic 1002 to displaying the fourth reference graphic 1006.

As can be seen, the number of state changes that the IMOD display panel IMODs undergo during each transition from the subject graphic 1002 to or from one of the reference graphics may vary by row and by reference graphic. In this example, the IMODs are actuated row-by-row, and acoustic artifacts resulting from these actuations may be detected by a suitable acoustic or vibrational sensor. The collected acoustic data may be used to determine or approximate the number of IMOD state changes experienced by each row. If the acoustic data is plotted as a function of row actuations, a pattern may be evident that may be used to fingerprint or authenticate the subject image 1002. Plot 1020 shows a plot of detected IMOD state changes by row. Due to the small size of the example display and the relative simplicity of the subject graphic 1002 and the reference graphics 1003-1006, the plot in this example is relatively static, but it does include observable drops and spikes in the number of state changes detected, which may be used to fingerprint the subject graphic. Larger resolution displays and more complex reference graphics (or greater numbers of reference graphics) may be used to obtain more complex acoustic fingerprints for a subject graphic.

For clarity, certain conventions have been adopted in FIG. 10. For example, each graphic is labeled with a letter. In the plot 1020, the vertical axis reflects the number of state changes experienced by the rows of the IMOD display panel, and the horizontal axis reflects the actuated rows, grouped by graphic. Thus, the numbers 1-8 immediately to the right of the letter “A” in plot 1020 represent the first through eighth rows of IMODs in the IMOD display panel, counting down from the topmost row. The letter “B” immediately underneath the leftmost “8” indicates that, after the state changes associated with the first through eighth rows bracketed by “A” and “B” are performed, the IMOD display panel will be displaying graphic “B.” The numbers 1-8 immediately to the right of the letter “B” in plot 1020 also represent the first through eighth rows of IMODs in the IMOD display panel, counting down from the topmost row. However, the letter “C” indicates that, after the state changes associated with the first through eighth rows bracketed by “B” and “C” are performed, the IMOD display panel will be displaying graphic “C.” This convention is followed for the remaining graphics as well.

It should be noted that while the plot 1020 depicts the number of detected state changes as a function of row actuation, similar profiles may be obtained by plotting detected acoustic artifact magnitude as a function of row actuation. This is because acoustic artifact magnitude, at a high level, may be largely governed by the number of IMOD actuations producing individual acoustic artifacts at approximately the same time, e.g., during a single row actuation of IMODs. The data may also be plotted as a function of time rather than as a function of row because, in many IMOD display panels, the frequency with which rows of IMODs are actuated remains relatively constant.

FIG. 11 depicts a flow diagram of a technique for obtaining acoustic artifact fingerprints or signatures of a subject graphic. The technique begins in block 1102, and includes identifying a subject image (block 1104), e.g., receiving direct or indirect instructions from a user or from a piece of software to authenticate a designated subject graphic. In block 1106, a reference graphic may be identified. In some cases, the reference graphic may be a pre-set graphic stored in a data repository, for example, the reference graphics of FIG. 10, and in other cases, the reference graphic may be calculated in real-time or near-real-time based on a preset function and a known input, e.g., transforming the subject graphic via a preset image manipulation function, such as taking a mirror image of the subject graphic, to produce a reference image.

Once the subject graphic and the reference graphic have been identified, an IMOD display panel may, in block 1108, be transitioned between the two graphics to produce acoustic artifacts. As discussed above, such acoustic artifacts may be produced by state changes experienced by IMODs in the IMOD display panel as the IMOD display panel transitions between graphics. As discussed above, each transition between graphics may involve actuations of groups of IMODs, e.g., by row, and each such group actuation may produce acoustic artifacts of different magnitudes depending on the number of IMODs actuated within the group. In block 1110, the acoustic artifacts may be detected by an appropriate acoustic or vibrational sensor. The sensor may, for example, be internal to the device housing the IMOD display panel, e.g., a microphone or vibration sensor in a cell phone equipped with an IMOD display panel, or external, e.g., a microphone outside of such a device but in close enough proximity to detect the acoustic artifacts.

In block 1112, a decision may be made as to whether or not blocks 1104 through 1110 should be repeated with an additional reference graphic or graphics. Additional cycles with different reference graphics may be used to produce additional acoustic artifact data that may be used to make a more positive identification or authentication of the subject graphic, as discussed above with respect to FIG. 10.

In block 1114, the detected acoustic artifacts may be processed to produce an acoustic artifact signature or fingerprint. This may involve simply transforming the sensor data into a time-history or other similar format, or may be more complex. For example, the acoustic artifact signature may be produced by evaluating the acoustic artifact data for each graphic transition and determining whether or not the detected acoustic artifact data falls within certain thresholds. Based on such determinations, each segment of acoustic artifact data associated with a different graphic may be assigned an appropriate value and the resulting chain of 0's or 1's may be assembled into a bitstream.

In block 1116, the acoustic artifact signature or fingerprint may be compared to a reference acoustic artifact signature or fingerprint. In block 1118, a determination may be made, based on the comparison, as to whether an acoustic artifact signature is valid. Such a determination may be made, for example, when there is an exact match between the two signatures, or when there is a sufficiently close match between the two signatures, e.g., the detected signature is within 10% of the reference signature. Other types of pattern matching may be used as appropriate. After determining if there is a valid match, the technique may end in block 1120.

Such techniques may be useful in authenticating content shown on an IMOD display panel. For example, it may be desirable to ensure that the content shown to a user of an IMOD display panel is actually the content that was sent to the device incorporating the IMOD display panel for display (rather than other content somehow inserted into the data stream). If the content is fingerprinted while being displayed on the IMOD display panel, the detected acoustic signature may be sent back to an authentication server or other verification system to compare against a reference acoustic signature. If the two signatures match, or match substantially, the displayed content may be evaluated as “authentic.” Such a comparison may not be an exact comparison, but may instead check to see if the detected acoustic signature falls within a certain bounded range that is calculated for the reference acoustic signature. For example, the reference acoustic signature may be associated with a bounded range that is defined as being within 10% of the magnitude of the reference acoustic signature. If the detected acoustic signature falls within that bounded range, then it may be considered to be a substantial match with the reference acoustic signature.

It should also be noted that, in one particular implementation, a series of reference images may be used that are identical to the subject image except for changing (if needed) one IMOD per reference image to the “dark” state. The number of reference graphics used in this particular case may be equal to the number of IMODs used to display the entire subject graphic, and a different pixel may be set to the “dark” state in each reference graphic (for reference graphics where the IMOD corresponding to the “darkened” pixel is already dark, the reference graphic would be identical to the subject graphic. Thus, each transition between a reference graphic and the subject graphic would produce either a single IMOD state change or no IMOD state change. The resulting acoustic artifact dataset would therefore represent a binary dataset that would exactly identify the subject graphic. Such analysis may be referred to as IMOD-by-IMOD, acoustic artifact analysis, and may be like a raster scan. Similar results may also be obtained by changing IMODs to the “bright” state rather than the “dark” state.

While the techniques described herein thus far, as well as in examples provided later in this document, have mostly focused on a row-by-row actuation scheme to drive IMOD display panels, such techniques may also be used in column-by-column actuation schemes with appropriate modification. The techniques may also be implemented using a pixel-by-pixel, sub-pixel-by-sub-pixel, multi-column, or multi-row technique based on the example techniques described herein.

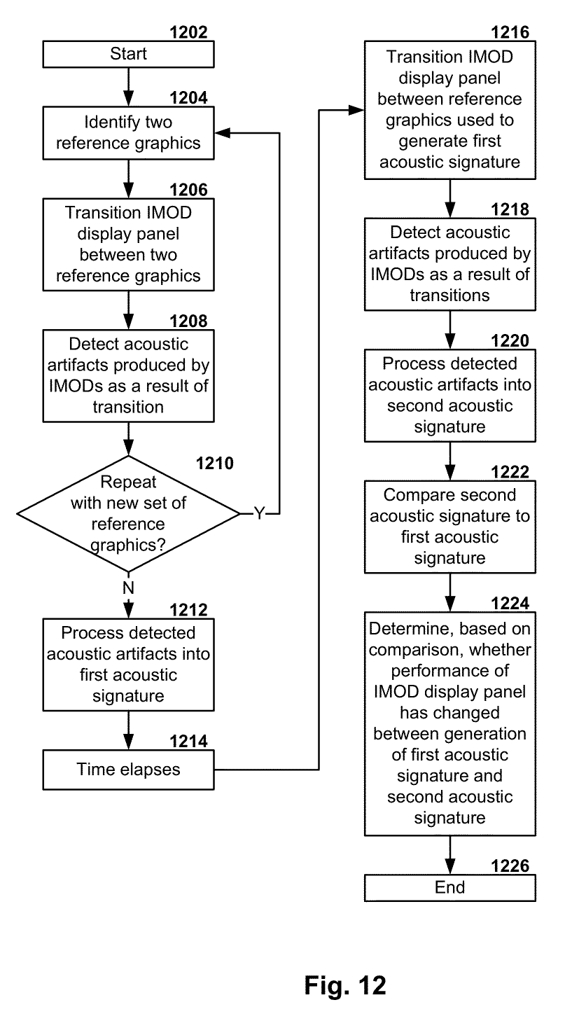

While the above discussion focuses on techniques for authenticating or fingerprinting a subject graphic using reference graphics, reference graphics may also be used to evaluate the hardware of an IMOD display panel. FIG. 12 depicts a flow diagram for one technique for evaluating the hardware of an IMOD display panel. After the technique begins in block 1202, two reference graphics may be identified in block 1204. For example, the IMOD display panel may be installed in an electronics device that includes a memory that stores two or more reference graphics, and two of these reference graphics may be identified in block 1204. In block 1206, the IMOD display panel may be transitioned between the two reference graphics to produce acoustic artifacts resulting from IMOD state changes necessary to perform the transitions, as discussed earlier in this paper. In block 1208, the acoustic artifacts may be detected by a suitable acoustic sensor or vibrational sensor, as discussed in previous examples. In block 1210, a decision may be made as to whether to repeat blocks 1204 through 1208 for other sets of reference graphics; these other sets of reference graphics may be completely different from the other sets of reference graphics or only partially different, e.g., one reference graphic may be the same, but the second may be changed.

In block 1212, the detected acoustic artifacts may be processed to produce a first acoustic signature using, for example, various techniques described in previous examples. This acoustic signature may then be stored for future reference, typically with some form of identification linking it to the IMOD display panel that produced the acoustic artifacts (or some other linkage to the IMOD display panel). Blocks 1202 through 1212 may be performed, for example, at a factory that produces an electronic device within which the IMOD display panel is housed, although these blocks may also be performed at other locations or after the manufacturing process is complete.

In block 1214, time elapses. The elapsed time may be quite significant, e.g., on the order of months or years, although shorter or longer time periods may also be used. The elapsed time represents a period of time that is relatively arbitrary since it represents the period between the collection of the first acoustic signature and the performance of blocks 1216 onwards. At some point, the IMOD display panel may, in block 1216, be caused to transition between the same set(s) of reference graphics used in blocks 1204 through 1208. Block 1216 may be initiated when it is desired to evaluate some aspects of the performance of the IMOD display panel hardware with respect to the same performance aspects of the IMOD display panel hardware at the time that the first acoustic signature was created. For example, block 1216 may be initiated in response to receiving a complaint from a user of the device having the IMOD display panel about aspects of the IMOD display panel performance. Alternatively, block 1216 may be initiated periodically throughout the lifetime of the IMOD display panel to monitor the performance or quality of the panel as it ages.

In block 1218, the acoustic artifacts generated in block 1216 may be detected by a suitable acoustic sensor or vibration sensor. In some implementations, the same sensor may be used to detect the acoustic artifacts in block 1218 as was used to detect the acoustic artifacts in block 1208. The detected acoustic artifacts may then be processed, in a manner similar to that used in block 1212, to produce a second acoustic signature in block 1220. The second acoustic signature may then be compared to the first acoustic signature in block 1222. A determination may be made in block 1224, based on the comparison from block 1222, as to whether or not there has been a change in performance of the IMOD display panel between blocks 1204 through 1212 and blocks 1216 through 1220. The technique may then end in block 1226.

For example, if IMODs in the IMOD display panel have suffered performance degradation or failure between the first time and the second time, the acoustic artifact signatures gathered at each time may be different from each other. By way of further example, if the acoustic artifact magnitude for a row of IMODs associated with a given state change is of a lesser magnitude at the second time than at the first time, then this may indicate that one or more IMODs in that row have failed. Such techniques may allow for rapid, in-situ performance evaluation of IMOD display panel-equipped products. For example, a cell phone with an IMOD display panel may be configured to display a series of reference graphics on the IMOD display panel. A microphone or other vibrational sensor within the cell phone may detect the acoustic artifacts produced by the IMOD display panel in the cell phone and relay the detected acoustic artifact data to a computing device that compares the detected acoustic signature with a reference acoustic signature generated, for example, with the same reference graphic or graphics prior to the cell phone's departure from its originating factory. This may allow for rapid, remote diagnosis of the IMOD display panel housed within the cell phone. Alternatively, such analysis and diagnosis may also occur locally using computing resources integral to the cell phone.

Another possible advantage of the technique depicted in FIG. 12 is that the resulting acoustic artifact signatures may be used to fingerprint or authenticate the actual display. For example, different IMOD display panels may produce slightly different acoustic artifact signatures when made to display the same reference graphic. By comparing a detected acoustic artifact signature against a reference acoustic artifact signature associated with a given IMOD display panel for the same reference graphic, a determination may be made as to whether the IMOD display panel producing the detected acoustic artifact signature is the same IMOD display panel that produced the reference acoustic artifact signature. In this manner, an IMOD display panel may be authenticated. Such techniques may be useful, for example, when a manufacturer wishes to determine remotely whether or not a customer's device has a factory-installed IMOD display panel still installed or if the factory-installed IMOD display panel has been replaced. Such determinations may guide customer service agents or result in a warranty being rendered void.

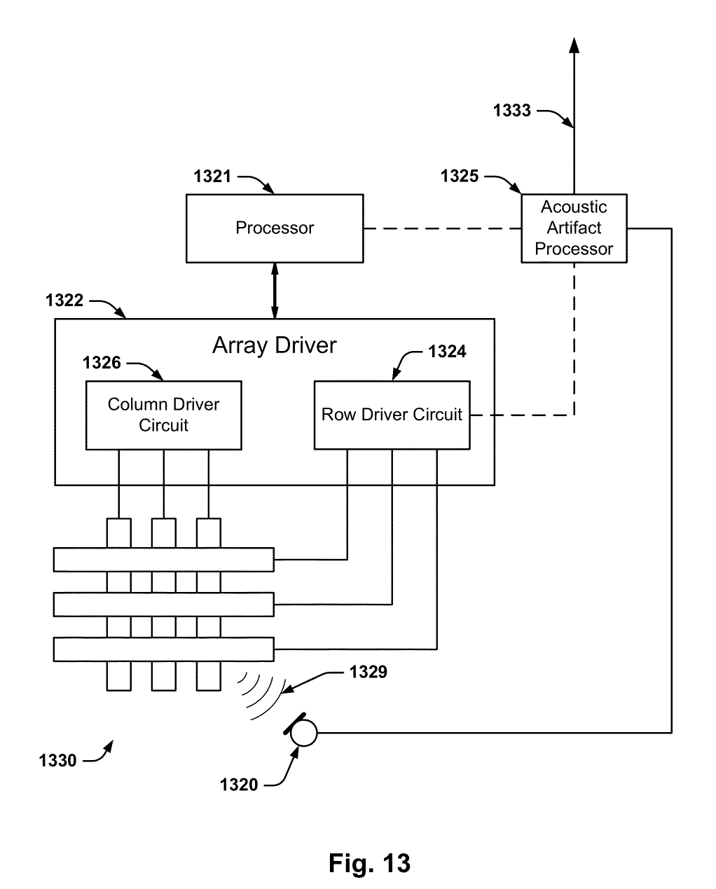

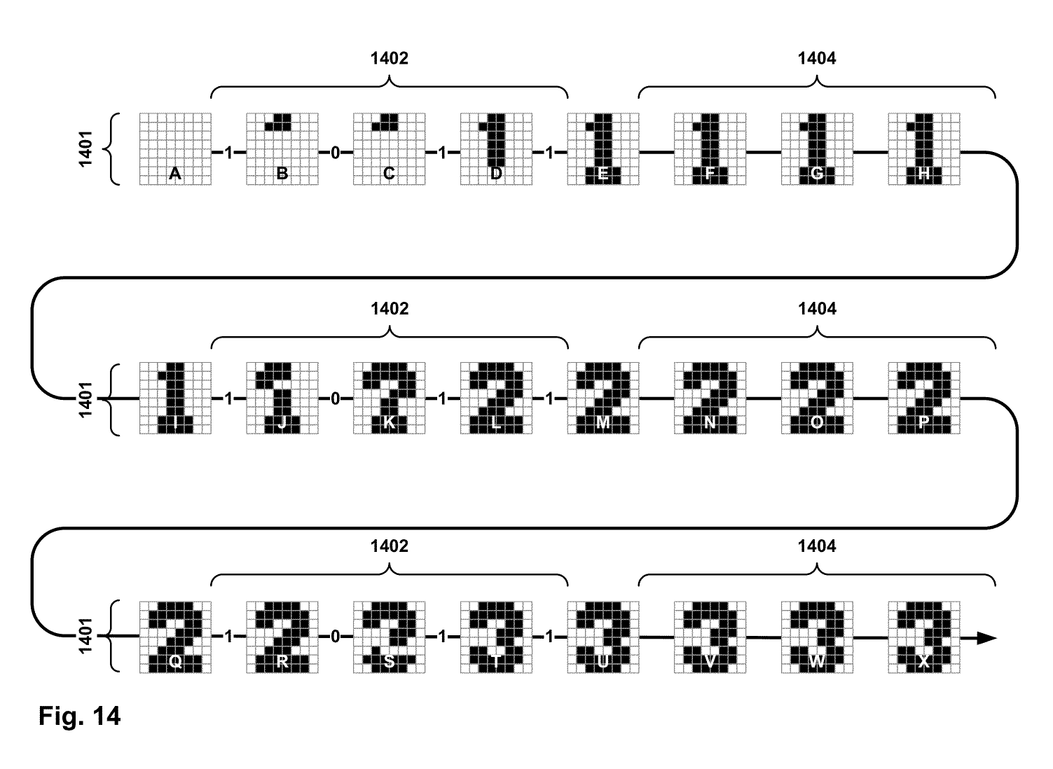

FIG. 13 depicts an example of a system block diagram illustrating an electronic device incorporating an IMOD display panel and an acoustic artifact detection system. The electronic device may include a processor 1321 that may be configured to execute one or more software modules. For instance, in addition to executing an operating system, the processor 1321 may be configured to execute one or more software applications, including a web browser, a telephone application, an email program, or other software application. In some implementations, such functionality may be spread across a plurality of processors.

The processor 1321 may be configured to communicate with an array driver 1322. The array driver 1322 may include a row driver circuit 1324 and a column driver circuit 1326 that provide signals to, e.g., an IMOD display array or panel 1330. Although FIG. 13 illustrates a 3×3 array of IMODs for the sake of clarity, the display array 1330 may contain a very large number of IMODs, and may have a different number of IMODs in rows than in columns, and vice versa.

Also shown in FIG. 13 is an acoustic artifact processor 1325. The acoustic artifact processor 1325 may be communicatively connected with an acoustic or vibrational detector 1320, which may be positioned so as to capture acoustic artifacts 1329 that are emitted by IMODs in the IMOD display array 1330. The acoustic artifact processor 1325 may, in some implementations, be communicatively coupled with row driver circuit 1324 (communication path shown by dashed line), column drive circuit 1326 (communication path not shown), and/or processor 1321 (communication path shown by dashed line). In these implementations, acoustic artifact processor 1325 may be configured to receive timing data regarding IMOD actuation cycles from one of the elements in the control path from the processor 1321 to the IMOD display array 1330, e.g., from row driver circuit 1324. This timing data may be utilized by the acoustic artifact processor to identify discrete acoustic artifact events and to facilitate generation of an acoustic artifact signature or fingerprint. The acoustic artifact processor 1325 may also be configured to forward on a generated acoustic signature or fingerprint to another device, e.g., a remote device via a wireless connection or other communication path such as communication path 1333. It is to be understood that some or all of the functionality provided by the components identified in FIG. 13 may be redistributed or combined as desired. For example, the processor 1321 may be configured to perform all of the functionality provided by the acoustic artifact processor 1325, and the acoustic artifact processor 1325 may not be present as a discrete component separate from the processor 1321. In some implementations, the acoustic artifact processor 1325 (or other component that provides similar functionality), may not be configured to receive any timing data describing when IMOD actuation cycles begin or end. In such implementations, the acoustic artifact processor 1325 may instead look to fiduciaries embedded within the acoustic artifacts to establish timing intervals for actuation cycles.

While the above techniques for using acoustic artifact data may be practiced with existing IMOD display panels and controllers, other techniques for utilizing acoustic artifacts may be practiced as well that involve changing how IMODs in an IMOD display panel are actuated so as to produce a desired set of acoustic artifacts while displaying one or more images or other graphical content. It is to be understood that acoustic artifacts are produced using either type of technique.

FIG. 14 depicts a series of images that may be displayed by an example IMOD display panel and that may also be used to communicate data via acoustic artifact emission. Specifically, FIG. 14 shows a series of 24 frames of graphical content 1401; each frame is labeled with a different letter for easy reference (the letter labels are not intended to be viewed as “part” of the graphical content displayed on the IMOD display panel despite being overlaid on the graphical content depicted) and consists of 64 pixels/IMODs. The rate at which the frames are displayed may be higher than the rate at which the human visual system can process visual input. Thus, the frames may not be discretely observable by most human observers and their graphical content may be adjusted to produce a string of acoustic artifacts as needed without disrupting the visual experience of a human observer.

In FIG. 14, for example, within each string of eight consecutive frames, the first four frames may be earmarked for graphical content display and also for acoustic artifact production, and the remaining four frames may be earmarked for graphical content display only. Thus, during the first four frames, the IMODs in the IMOD display panel may undergo state changes from frame to frame that produce a desired acoustic artifact signature. During the last four frames, the IMODs may not undergo any state changes and the graphical content produced may not change from frame to frame. This cycle may then repeat for the next eight consecutive frames, and so on. In this example, the graphical content pictured consists of images of the numbers “1,” “2,” and “3,” although other content could be used as desired.

In this simple example, data that is intended to be conveyed using acoustic artifacts produced by the IMODs is reduced to a binary datastream. A “1” in the binary datastream may correlate with an acoustic artifact production/detection event, and a “0” may correlate with an absence of an acoustic artifact production/detection event. The potential state changes between the first five frames of each eight-frame set may be earmarked for producing such a datastream. Thus, a datastream of 101111100110 could be broken up into three 4-bit subgroups: 1011, 1110, and 0110. Each of these subgroups may then be broken up by frame transition. Thus, for the first subgroup, the frame transition from A to B may be required to correlate with a 1, the frame transition from B to C may be required to correlate with a 0, the frame transition from C to D may be required to correlate with a 1, and the frame transition from D to E may be required to correlate with a 1. In FIG. 14, the bit value associated with the first four state changes in each 8-frame group are indicated in between each frame.

Thus, in order to produce the desired acoustic artifacts representing the first 4-bit subgroup, all of the frame transitions between frames A-E, excepting the frame transition from B to C, may be controlled to produce an acoustic artifact. There may be multiple ways of accomplishing this. Thus, for example, in the transition from frame A to frame B, the top five IMODs of the number “1” may experience state changes and produce acoustic artifacts. In the transition from frame B to frame C, however, no IMODs experience state changes, and no acoustic artifacts are produced. In the transition from frame C to frame D, eight further IMODs experience state changes and produce acoustic artifacts; a similar event occurs in the transition from frame D to frame E. Thus, an acoustic sensor or other vibration detector in close proximity to the IMOD display may detect the acoustic artifacts and produce an acoustic artifact signature of the first four bits. The detected acoustic artifact signature may then be analyzed, transformed back into a bitstream, and handled appropriately. In this particular example, the only acoustic artifact data that needs to be detected is whether or not any acoustic artifact was detected, although, as discussed later, other implementations may make use of the magnitude of a detected acoustic artifact as well.

In the example from FIG. 14, the second and third subgroups may be handled in a similar manner. For example, to produce the second 4-bit subgroup, the transitions between frames I-L may each be controlled to produce acoustic artifacts and the transition from frame L to frame M may be controlled to have no state changes, i.e., produce no acoustic artifacts. To complete the example, to produce the third 4-bit subgroup, the transitions between frames R-T may each be controlled to produce acoustic artifacts and the transitions from frame Q to frame R and from frame T to frame U may be controlled to have no state changes, i.e., produce no acoustic artifacts. The acoustic artifacts produced may, as discussed above, be detected, analyzed, and transformed back into a datastream, e.g., 101111100110.

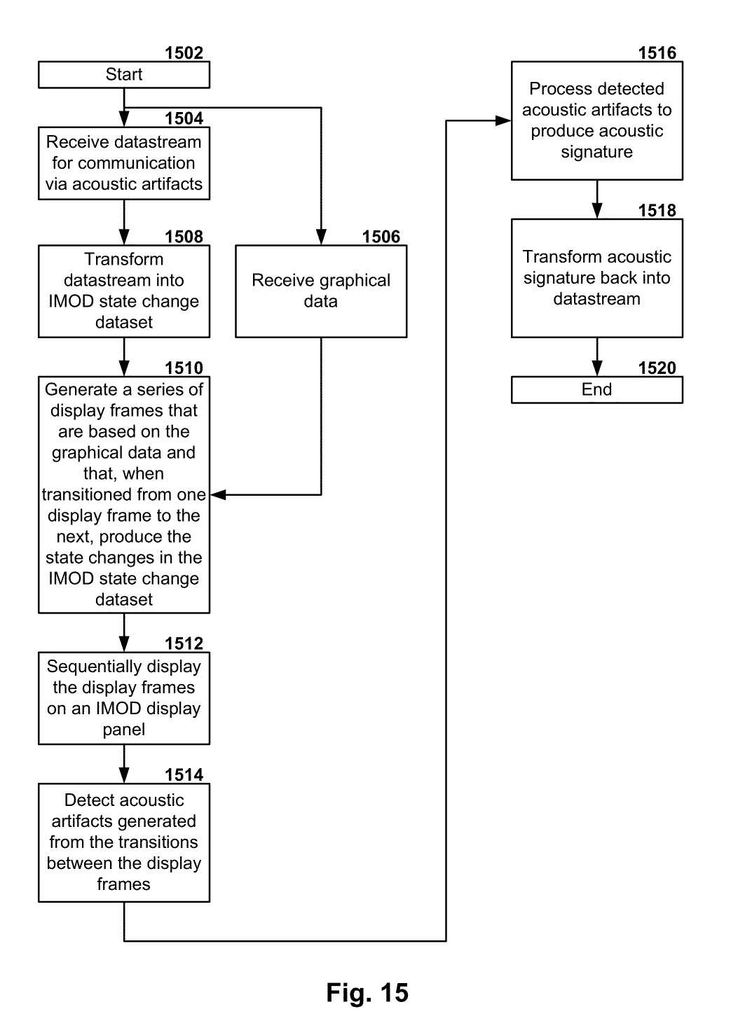

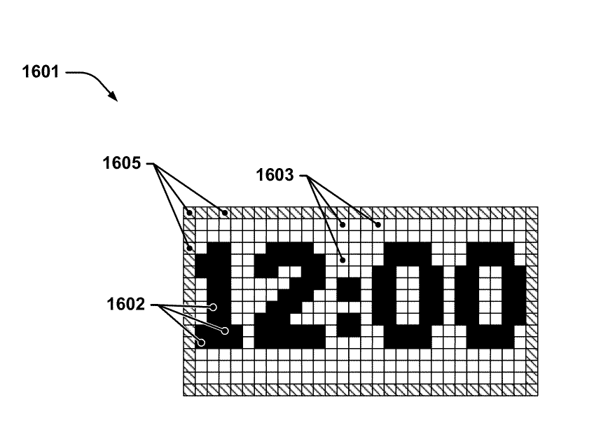

FIG. 15 depicts a flow diagram for an example technique for transmitting data via acoustic artifacts while displaying graphical content on an IMOD display panel. The technique begins in block 1502. In block 1504, a dataset or a datastream intended for transmission via acoustic artifacts may be received. Such a dataset or datastream may, for example, be received via a communications link from a remote source, e.g., via a wireless link, or may be obtained locally, e.g., retrieved from a storage medium in the device housing an IMOD display panel. Graphical data may also be received in block 1506. In block 1508, the datastream or dataset may be transformed into an IMOD state change dataset. This may involve, for example, mapping discrete values in the datastream or dataset to state changes that produce acoustic artifacts that, when detected, can be processed to extract the datastream or dataset values. For example, for a binary bitstream, block 1508 may include producing a dataset in which each 0 value may be represented by a “no state change” row actuation and each 1 value may be represented by a “state change” row actuation event.

Next, in block 1510, the graphical data may be processed to produce a series of display frames (referred to simply as “frames” in previous discussion) that are based on the graphical data but that also produce the desired state changes reflected in the IMOD state change dataset. This process may, for example, involve dividing the graphical content into multiple subportions, each of which may be displayed for a given display frame when production of an acoustic artifact is desired. At times when an acoustic artifact is not desired, the most recent display frame shown may be re-displayed (resulting in no state changes and no acoustic artifact generation). This process is similar to that shown in FIG. 14.

In block 1512, the display frames produced in block 1514 may be sequentially displayed. The sequential display of the display frames may thus produce a sequence of acoustic artifacts (“clicks” and “non-clicks”) that may be detected in block 1514. The detected acoustic artifacts may then be processed in block 1516 to produce an acoustic signature and then transformed back into the datastream in block 1518. The technique may end in block 1520.

One example of how such data transmission may be used may be observed in the case of a cell phone with an IMOD display panel that may be used to display a bar code for scanning by a bar code scanner. The IMOD display panel may be controlled, in addition to displaying the bar code, to actuate the various IMODs used to provide the bar code display to also simultaneously produce acoustic artifacts, as discussed above, e.g., display subportions of the bar code graphic spread across multiple frames to produce acoustic artifacts at desired intervals. The data transmitted via acoustic artifacts may, for example, be a redundant backup of the bar code itself that may be detected by an acoustic detector on the bar code scanner and used by the bar code scanner to determine the bar code value in the event that the bar code is otherwise unreadable, e.g., obscured, subject to high glare, or read by a defective bar code scanner. In some implementations, the acoustic artifact bitstream may be used to convey additional information beyond that conveyed in the bar code display, e.g., the identity of the person who owns the cell phone, or information completely unrelated to the bar code display. Of course, while the acoustic artifact bitstream is being produced, the IMOD display panel may still display the bar code for optical scanning.

It is to be understood that there may be many variations on the above technique that may be used depending on the situation. To begin with, particular values chosen for the above example may be varied as appropriate, e.g., the number of frames per the overall number of frames in a given period that are used to produce acoustic artifacts may be increased or decreased. Another parameter that may be changed is how the acoustic-artifact-producing frames are interwoven with the non-acoustic-artifact-producing frames. For example, in the above discussion, each set of four acoustic-artifact-producing frames was followed by four non-acoustic-artifact-producing frames. Other implementations may feature such frames interwoven in a 1:1 ratio. In some implementations, every frame may include acoustic artifact content.

Another potential parameter that may be adjusted is the base unit that the bitstream is in. In the above example, the bitstream is a true bitstream, i.e., composed of 1's and 0's. However, since the measurement of acoustic artifact content may provide a magnitude, the “bits” in question may not actually be bits, i.e., binary, but may instead be in a base other than binary. For example, if a suitably sensitive acoustic detector or vibration sensor is used with the IMOD display panel of FIG. 14, the number of individual IMOD actuations may be detected based on the magnitude of the detected acoustic artifact signal. For example, during each frame transition, between 0 and 9 IMODs may change states, resulting in a base 10, i.e., decimal, data stream. Thus, if each individual state change in an IMOD were detectable in the system of FIG. 14, the resulting decimal datastream would be 508868600530 (ignoring the frames not used to convey acoustic artifact data).

In the examples above, the presence or absence of an acoustic artifact at various points in time, i.e., during frame transitions where acoustic artifact data may be expected, may be used to determine what data is embedded within the acoustic artifact datastream. However, since the absence of an acoustic artifact may occur at times other than at frame transitions where acoustic artifact data may be expected, a filtering mechanism may be employed to prevent the absence of acoustic artifacts at times other than such frame transitions from being wrongly viewed as representing acoustic artifact data. For example, in FIG. 14, the last four frames of each set of eight frames are not intended to communicate acoustic artifact data and may thus be left “static,” i.e., not changing state at all.

The examples herein have also focused only on IMOD display panels with one IMOD per pixel and that can only produce two different states of light reflection. However, similar techniques may be used with more complex IMOD display panels, such as multi-color IMOD display panels and/or IMOD display panels with subpixels. For example, each pixel of a color IMOD display panel may feature multiple IMODs, each configured to reflect a different wavelength of light. Thus, the state changes involved may produce different magnitudes of acoustic artifacts per pixel, as opposed to a single magnitude per pixel.

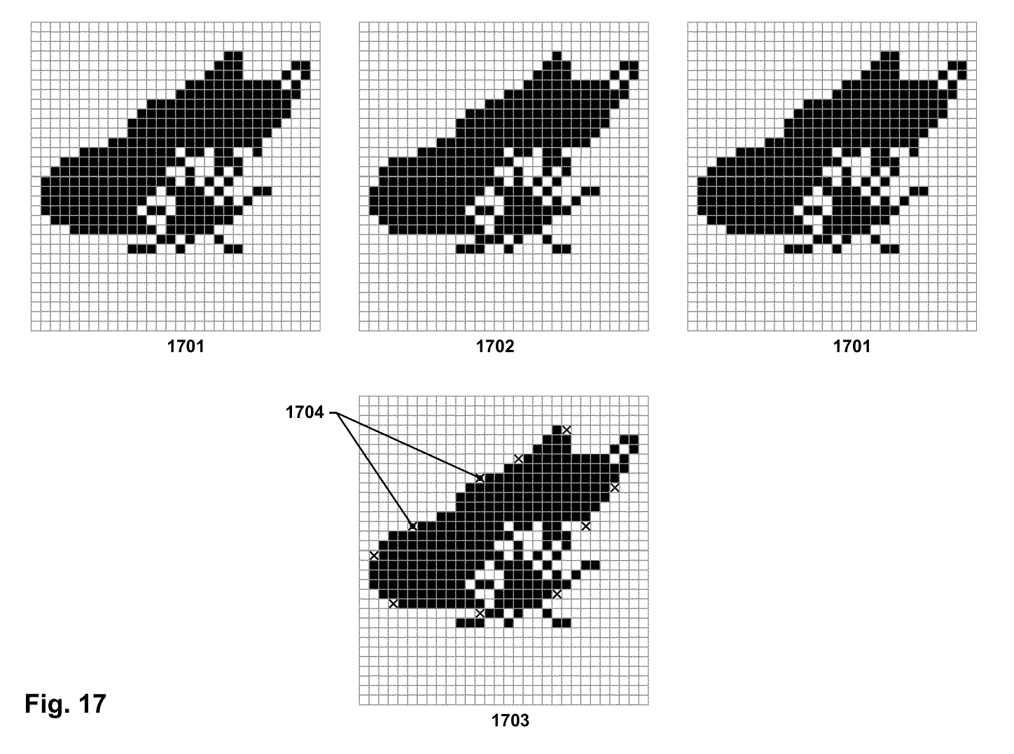

In some implementations, regions of an IMOD display panel that are hidden from view may be utilized to convey acoustic artifact content without any concern for corrupting a visual display due to IMOD state changes. For example, the outer perimeter of an IMOD display may not be visible to a user due to overlap by a bezel or other obscuring feature. IMOD elements within this outer perimeter may thus be actuated without worry that visual artifacts produced by such actuations will interfere with the viewing of graphical content by a user. While fluctuations in graphical content may be reduced by changing the state of fewer IMODs at any one time (and distributing such state changes in a diffuse manner across an IMOD display, as discussed later with reference to FIG. 17), the number of IMODs that may be available to produce state changes and acoustic artifacts may be sufficiently low that the acoustic artifacts produced are of an undesirably low magnitude. Using an occluded border region of an IMOD display as an acoustic artifact generator allows for a large number of IMODs to be used to produce acoustic artifacts without any interference with the graphical content displayed in the interior region of the IMOD display panel.

FIG. 16 depicts an example of an IMOD display panel with a peripheral region of IMODs reserved for acoustic artifact production and an interior region of IMODs reserved for graphical content display. IMOD display panel 1601 may, as shown in this example, be a 16×30 pixel/IMOD display panel. IMODs in the periphery 1605 of the IMOD display panel 1601 may be reserved for acoustic artifact production. The IMODs in the periphery 1605 of the IMOD display panel 1601 may, for example, be obscured from view due to the overlap of a bezel (not shown). The IMOD display panel 1601 may also include IMODs in an interior region, such as IMODs 1602 (in a dark state) and 1603 (in a bright state). State changes in the IMODs in the periphery 1605 may result in no visible changes at all to the graphical content that is displayed by the interior IMODs. Thus, from display frame to display frame, the only IMODs that would change state to convey data via acoustic artifact production would be those in the periphery 1605. Of course, some implementations may use a different configuration of “periphery” IMODs. For example, instead of a closed rectangular loop of IMODs as shown in FIG. 16, the periphery IMODs used for acoustic artifact production may only include a single row of IMODs at the top or bottom of the IMOD display (or a single column on the left or the right side).

FIG. 17 shows another example of generating image frames that may be used to convey data via acoustic artifact production. In FIG. 17, three display frames are shown. Display frames 1701 bracket display frame 1702. To a human observer, the images shown in all three display frames may appear substantially identical. However, ten IMODs in display frame 1702 have experienced state changes (and will produce acoustic artifacts) as compared with display frames 1701. These 10 IMODs are indicated by IMODs 1704 in IMOD display panel 1703. In one implementation, the same set of IMODs may be switched between states (or left alone) during each actuation cycle to produce the desired acoustic artifacts. IMODs 1704 may be selected such that they are on a boundary between IMODs that are in a bright state and IMODs that are in a dark state. This may make it less apparent to a human observer that the graphical content displayed by the IMOD display panel is changing. For example, to a human observer, it may appear that the edges of the displayed graphic are shimmering slightly, but such minor variation may not be as noticeable as if blocks of contiguous IMODs were transitioned as a unit.

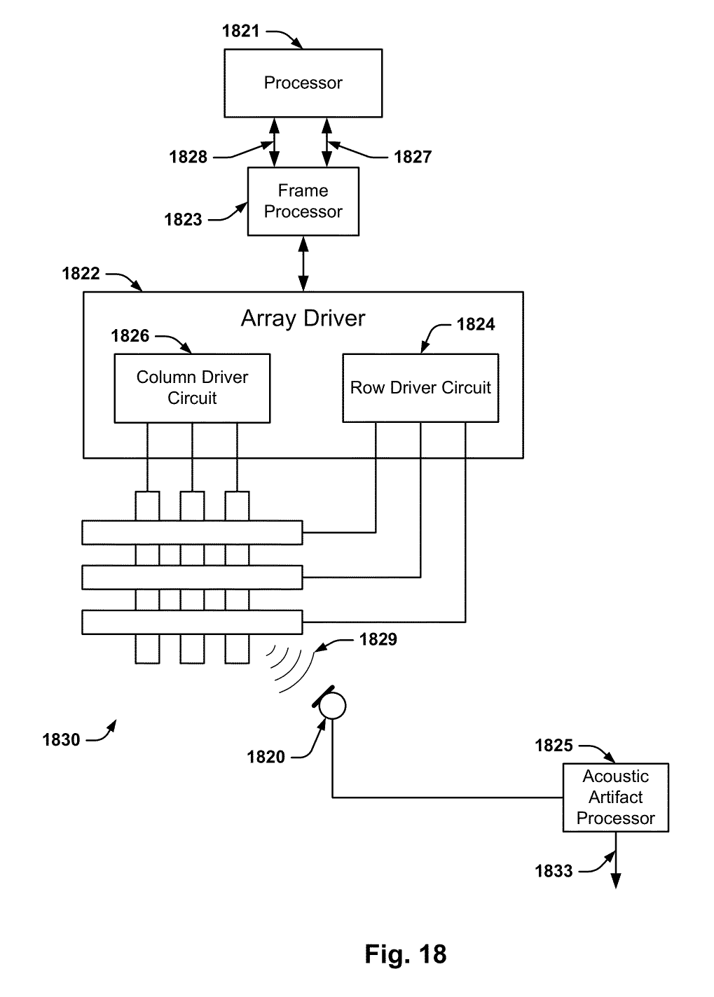

FIG. 18 depicts an example of a system block diagram illustrating an electronic device incorporating an IMOD display panel and an acoustic artifact provisioning system. The electronic device may include a processor 1821 that may be configured to execute one or more software modules. For example, in addition to executing an operating system, the processor 1821 may be configured to execute one or more software applications, including a web browser, a telephone application, an email program, or other software application. In some implementations, such functionality may be spread across a plurality of processors.

The processor 1821 may be configured to communicate with a frame processor 1823. The frame processor 1823 may be configured to receive graphical content data 1828 as well as data destined for acoustic artifact transmission 1827. While the graphical content data 1828 and the data destined for acoustic artifact transmission 1827 are shown as being provided to the frame processor 1823 using separate transmission paths, such segregation is not necessary. However, graphical content data 1828 and the data destined for acoustic artifact transmission 1827 may nonetheless be independent data streams.

The frame processor 1823 may be configured to transform the data destined for acoustic artifact transmission into an IMOD state change dataset, as described with respect to FIG. 15. The frame processor 1823 may also be configured to examine the graphical content 1828 and to produce a plurality of display frames that may be used to display the graphical content 1828 on a display. Each display frame may be produced as described, for example, with reference to FIG. 15 or to other portions of this application. The frame processor 1823 may then forward the display frame data to an array driver 1822. The array driver 1822 may include a row driver circuit 1824 and a column driver circuit 1826 that provide signals to, e.g., an IMOD display array or panel 1830. Although FIG. 18 illustrates a 3×3 array of IMODs for the sake of clarity, the display array 1830 may contain a very large number of IMODs, and may have a different number of IMODs in rows than in columns, and vice versa.

Also shown in FIG. 18 is an acoustic artifact processor 1825. The acoustic artifact processor 1825 may be communicatively connected with acoustic or vibrational detector 1820, which may be positioned so as to capture acoustic artifacts 1829 that are emitted by IMODs in the IMOD display array 1830. While the acoustic artifact processor 1825 may, in some implementations, be communicatively coupled with row driver circuit 1824, column drive circuit 1826, and/or processor 1821 in a manner similar to that shown in FIG. 13, in many implementations, such as that shown, the acoustic artifact processor 1825 and the acoustic or vibrational detector 1820 may be located in a device separate from the device housing the IMOD display array 1830 and the processor 1821 and not be connected to components in the electronic device. In these implementations, the acoustic artifact processor 1825 may look to fiduciary patterns embedded within the acoustic artifacts to establish timing intervals for actuation cycles.

The acoustic artifact processor 1825 may be configured to analyze the acoustic artifacts 1829 detected by the acoustic or vibrational detector 1820 and to transform the detected acoustic artifact data back into a datastream. The acoustic artifact processor 1825 may accomplish this using, for example, techniques outlined above.

The acoustic artifact processor 1825 may also be configured to forward on the re-created datastream to another device, e.g., a remote device via a wireless connection or other communication path such as communication path 1833. It is to be understood that some or all of the functionality provided by the components identified in FIG. 18 may be redistributed or combined as desired. For example, the processor 1821 may be configured to perform all of the functionality provided by the frame processor 1823, and the frame processor 1823 may not be present as a discrete component separate from the processor 1821.

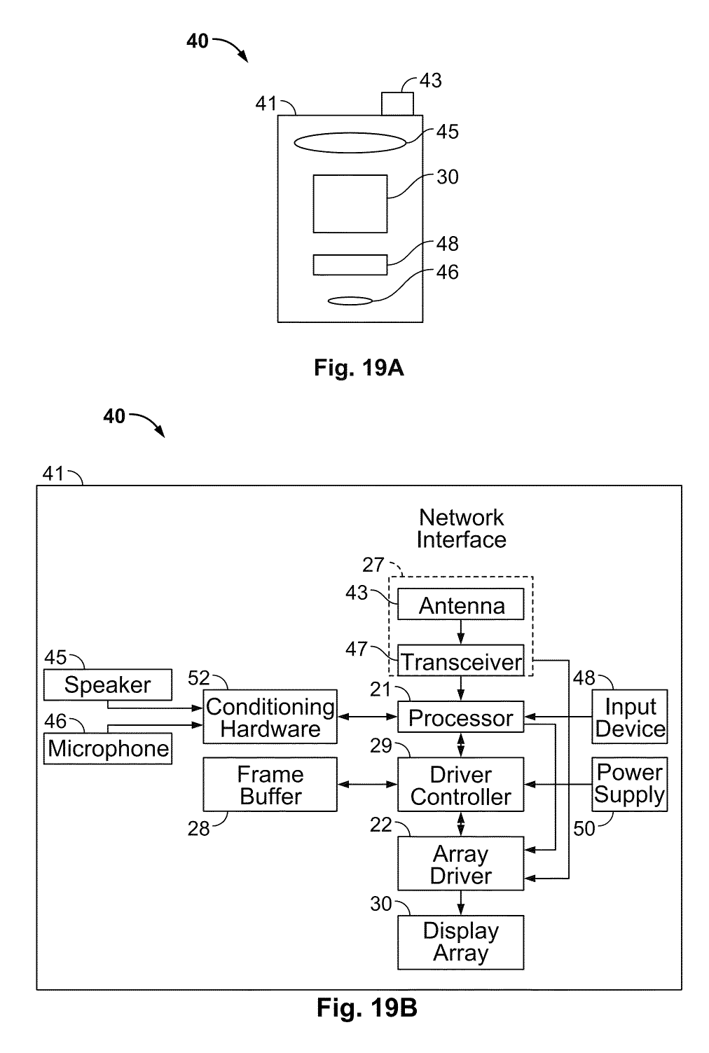

FIGS. 19A and 19B show examples of system block diagrams illustrating a display device 40 that includes a plurality of interferometric modulators. The display device 40 can be, for example, a cellular or mobile telephone. However, the same components of the display device 40 or slight variations thereof are also illustrative of various types of display devices such as televisions, e-readers and portable media players.

The display device 40 includes a housing 41, a display 30, an antenna 43, a speaker 45, an input device 48, and a microphone 46. The housing 41 can be formed from any of a variety of manufacturing processes, including injection molding, and vacuum forming. In addition, the housing 41 may be made from any of a variety of materials, including, but not limited to: plastic, metal, glass, rubber, and ceramic, or a combination thereof. The housing 41 can include removable portions (not shown) that may be interchanged with other removable portions of different color, or containing different logos, pictures, or symbols.

The display 30 may be any of a variety of displays, including a bi-stable or analog display, as described herein. The display 30 also can be configured to include a flat-panel display, such as plasma, EL, OLED, STN LCD, or TFT LCD, or a non-flat-panel display, such as a CRT or other tube device. In addition, the display 30 can include an interferometric modulator display, as described herein.

The components of the display device 40 are schematically illustrated in FIG. 19B. The display device 40 includes a housing 41 and can include additional components at least partially enclosed therein. For example, the display device 40 includes a network interface 27 that includes an antenna 43 which is coupled to a transceiver 47. The transceiver 47 is connected to a processor 21, which is connected to conditioning hardware 52. The conditioning hardware 52 may be configured to condition a signal (e.g., filter a signal). The conditioning hardware 52 is connected to a speaker 45 and a microphone 46. The processor 21 is also connected to an input device 48 and a driver controller 29. The driver controller 29 is coupled to a frame buffer 28, and to an array driver 22, which in turn is coupled to a display array 30. A power supply 50 can provide power to all components as required by the particular display device 40 design.

The network interface 27 includes the antenna 43 and the transceiver 47 so that the display device 40 can communicate with one or more devices over a network. The network interface 27 also may have some processing capabilities to relieve, e.g., data processing requirements of the processor 21. The antenna 43 can transmit and receive signals. In some implementations, the antenna 43 transmits and receives RF signals according to the IEEE 16.11 standard, including IEEE 16.11(a), (b), or (g), or the IEEE 802.11 standard, including IEEE 802.11a, b, g or n. In some other implementations, the antenna 43 transmits and receives RF signals according to the BLUETOOTH standard. In the case of a cellular telephone, the antenna 43 is designed to receive code division multiple access (CDMA), frequency division multiple access (FDMA), time division multiple access (TDMA), Global System for Mobile communications (GSM), GSM/General Packet Radio Service (GPRS), Enhanced Data GSM Environment (EDGE), Terrestrial Trunked Radio (TETRA), Wideband-CDMA (W-CDMA), Evolution Data Optimized (EV-DO), 1xEV-DO, EV-DO Rev A, EV-DO Rev B, High Speed Packet Access (HSPA), High Speed Downlink Packet Access (HSDPA), High Speed Uplink Packet Access (HSUPA), Evolved High Speed Packet Access (HSPA+), Long Term Evolution (LTE), AMPS, or other known signals that are used to communicate within a wireless network, such as a system utilizing 3G or 4G technology. The transceiver 47 can pre-process the signals received from the antenna 43 so that they may be received by and further manipulated by the processor 21. The transceiver 47 also can process signals received from the processor 21 so that they may be transmitted from the display device 40 via the antenna 43.

In some implementations, the transceiver 47 can be replaced by a receiver. In addition, the network interface 27 can be replaced by an image source, which can store or generate image data to be sent to the processor 21. The processor 21 can control the overall operation of the display device 40. The processor 21 receives data, such as compressed image data from the network interface 27 or an image source, and processes the data into raw image data or into a format that is readily processed into raw image data. The processor 21 can send the processed data to the driver controller 29 or to the frame buffer 28 for storage. Raw data typically refers to the information that identifies the image characteristics at each location within an image. For example, such image characteristics can include color, saturation, and gray-scale level.

The processor 21 can include a microcontroller, CPU, or logic unit to control operation of the display device 40. The conditioning hardware 52 may include amplifiers and filters for transmitting signals to the speaker 45, and for receiving signals from the microphone 46. The conditioning hardware 52 may be discrete components within the display device 40, or may be incorporated within the processor 21 or other components.

The driver controller 29 can take the raw image data generated by the processor 21 either directly from the processor 21 or from the frame buffer 28 and can re-format the raw image data appropriately for high speed transmission to the array driver 22. In some implementations, the driver controller 29 can re-format the raw image data into a data flow having a raster-like format, such that it has a time order suitable for scanning across the display array 30. Then the driver controller 29 sends the formatted information to the array driver 22. Although a driver controller 29, such as an LCD controller, is often associated with the system processor 21 as a stand-alone Integrated Circuit (IC), such controllers may be implemented in many ways. For example, controllers may be embedded in the processor 21 as hardware, embedded in the processor 21 as software, or fully integrated in hardware with the array driver 22.

The array driver 22 can receive the formatted information from the driver controller 29 and can re-format the video data into a parallel set of waveforms that are applied many times per second to the hundreds, and sometimes thousands (or more), of leads coming from the display's x-y matrix of pixels.

In some implementations, the driver controller 29, the array driver 22, and the display array 30 are appropriate for any of the types of displays described herein. For example, the driver controller 29 can be a conventional display controller or a bi-stable display controller (e.g., an IMOD controller). Additionally, the array driver 22 can be a conventional driver or a bi-stable display driver (e.g., an IMOD display driver). Moreover, the display array 30 can be a conventional display array or a bi-stable display array (e.g., a display including an array of IMODs). In some implementations, the driver controller 29 can be integrated with the array driver 22. Such an implementation is common in highly integrated systems such as cellular phones, watches and other small-area displays.

In some implementations, the input device 48 can be configured to allow, e.g., a user to control the operation of the display device 40. The input device 48 can include a keypad, such as a QWERTY keyboard or a telephone keypad, a button, a switch, a rocker, a touch-sensitive screen, or a pressure- or heat-sensitive membrane. The microphone 46 can be configured as an input device for the display device 40. In some implementations, voice commands through the microphone 46 can be used for controlling operations of the display device 40.

The power supply 50 can include a variety of energy storage devices as are well known in the art. For example, the power supply 50 can be a rechargeable battery, such as a nickel-cadmium battery or a lithium-ion battery. The power supply 50 also can be a renewable energy source, a capacitor, or a solar cell, including a plastic solar cell or solar-cell paint. The power supply 50 also can be configured to receive power from a wall outlet.

In some implementations, control programmability resides in the driver controller 29 which can be located in several places in the electronic display system. In some other implementations, control programmability resides in the array driver 22. The above-described optimization may be implemented in any number of hardware and/or software components and in various configurations.

The various illustrative logics, logical blocks, modules, circuits and algorithm steps described in connection with the implementations disclosed herein may be implemented as electronic hardware, computer software, or combinations of both. The interchangeability of hardware and software has been described generally, in terms of functionality, and illustrated in the various illustrative components, blocks, modules, circuits and steps described above. Whether such functionality is implemented in hardware or software depends upon the particular application and design constraints imposed on the overall system.

The hardware and data processing apparatus used to implement the various illustrative logics, logical blocks, modules and circuits described in connection with the aspects disclosed herein may be implemented or performed with a general purpose single- or multi-chip processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general purpose processor may be a microprocessor, or, any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration. In some implementations, particular steps and methods may be performed by circuitry that is specific to a given function.

In one or more aspects, the functions described may be implemented in hardware, digital electronic circuitry, computer software, firmware, including the structures disclosed in this specification and their structural equivalents thereof, or in any combination thereof. Implementations of the subject matter described in this specification also can be implemented as one or more computer programs, i.e., one or more modules of computer program instructions, encoded on a computer storage media for execution by, or to control the operation of, data processing apparatus.

If implemented in software, the functions may be stored on or transmitted over as one or more instructions or code on a computer-readable medium. The steps of a method or algorithm disclosed herein may be implemented in a processor-executable software module which may reside on a computer-readable medium. Computer-readable media includes both computer storage media and communication media including any medium that can be enabled to transfer a computer program from one place to another. A storage media may be any available media that may be accessed by a computer. By way of example, and not limitation, such computer-readable media may include RAM, ROM, EEPROM, CD-ROM or other optical disk storage, magnetic disk storage or other magnetic storage devices, or any other medium that may be used to store desired program code in the form of instructions or data structures and that may be accessed by a computer. Also, any connection can be properly termed a computer-readable medium. Disk and disc, as used herein, includes compact disc (CD), laser disc, optical disc, digital versatile disc (DVD), floppy disk, and blu-ray disc where disks usually reproduce data magnetically, while discs reproduce data optically with lasers. Combinations of the above should also be included within the scope of computer-readable media. Additionally, the operations of a method or algorithm may reside as one or any combination or set of codes and instructions on a machine readable medium and computer-readable medium, which may be incorporated into a computer program product.

Various modifications to the implementations described in this disclosure may be readily apparent to those skilled in the art, and the generic principles defined herein may be applied to other implementations without departing from the spirit or scope of this disclosure. Thus, the disclosure is not intended to be limited to the implementations shown herein, but is to be accorded the widest scope consistent with the claims, the principles and the novel features disclosed herein. The word “exemplary” is used exclusively herein to mean “serving as an example, instance, or illustration.” Any implementation described herein as “exemplary” is not necessarily to be construed as preferred or advantageous over other implementations. Additionally, a person having ordinary skill in the art will readily appreciate, the terms “upper” and “lower” are sometimes used for ease of describing the figures, and indicate relative positions corresponding to the orientation of the figure on a properly oriented page, and may not reflect the proper orientation of the IMOD as implemented.

Certain features that are described in this specification in the context of separate implementations also can be implemented in combination in a single implementation. Conversely, various features that are described in the context of a single implementation also can be implemented in multiple implementations separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the implementations described above should not be understood as requiring such separation in all implementations, and it should be understood that the described program components and systems can generally be integrated together in a single software product or packaged into multiple software products. Additionally, other implementations are within the scope of the following claims. In some cases, the actions recited in the claims can be performed in a different order and still achieve desirable results.

What is claimed is:

1. A method comprising:
detecting a first set of acoustic artifacts produced by state changes in interferometric modulators (IMODs) of an IMOD display panel arising from the display of a subject graphic by the IMOD display panel at a first time;
comparing the first set of acoustic artifacts against reference data associated with the subject graphic; and
performing an authentication process based, at least in part, on the comparing to authenticate at least one of the subject graphic and the IMOD display panel.

2. The method of claim 1, further comprising causing a display of a first reference graphic by the IMOD display panel immediately prior to or immediately after the display of the subject graphic, wherein the reference data is further associated with the first reference graphic and the first set of acoustic artifacts is produced by state changes in the IMODs of the IMOD display panel arising from the display of the subject graphic immediately after the first reference graphic or from the display of the first reference graphic immediately after the subject graphic.

3. The method of claim 2, further comprising:
causing displays of second through Nth reference graphics on the IMOD display panel, wherein N is an integer with a value of 2 or greater;
causing a display of the subject graphic on the IMOD display panel immediately prior to or immediately after the display of each of the second through Nth reference graphics;
detecting second through Nth sets of acoustic artifacts, each of the second through Nth sets of acoustic artifacts produced by state changes in the IMODs arising from the display of a corresponding reference graphic of the second through Nth reference graphics immediately prior to or immediately after the subject graphic;
comparing each set of acoustic artifacts in the second through Nth sets of acoustic artifacts against the reference data, wherein:
the reference data is further associated with the second through Nth reference graphics, and
the authentication process is based in further part on the comparing each set of acoustic artifacts in the second through Nth sets of acoustic artifacts against the reference data.

4. The method of claim 3, wherein each of the first through Nth reference graphics differs from each of the other first through Nth reference graphics.

5. The method of claim 1, wherein:
the reference data includes data derived from acoustic artifacts produced by state changes in the IMODs arising from the display of the subject graphic by the IMOD display panel at a second time earlier than the first time, and
the authentication process authenticates the IMOD display panel.

6. An apparatus comprising:
an input interface; and
a controller, the controller comprising:
at least one processor, and
at least one memory, the at least one memory operably connected with the at least one processor and storing instructions executable by the at least one processor, the instructions comprising instructions to control the at least one processor to:
receive data from the input interface describing a first set of acoustic artifacts produced by state changes in interferometric modulators (IMODs) of an IMOD display panel arising from the display of a subject graphic by the IMOD display panel at a first time,
compare the first set of acoustic artifacts against reference data associated with the subject graphic, and
perform an authentication process based, at least in part, on the comparison of the first set of acoustic artifacts against reference data associated with the subject graphic to authenticate at least one of the subject graphic and the IMOD display panel.

7. The apparatus of claim 6, the instructions further comprising instructions to control the at least one processor to cause a display of a first reference graphic by the IMOD display panel immediately prior to or immediately after the display of the subject graphic, wherein the reference data is further associated with the first reference graphic and the first set of acoustic artifacts is produced by state changes in the IMODs of the IMOD display panel arising from the display of the subject graphic immediately after the first reference graphic or from the display of the first reference graphic immediately after the subject graphic.

8. The apparatus of claim 7, the instructions further comprising instructions to control the at least one processor to:
cause displays of second through Nth reference graphics on the IMOD display panel, wherein N is an integer with a value of 2 or greater;
cause a display of the subject graphic on the IMOD display panel immediately prior to or immediately after the display of each of the second through Nth reference graphics;
receive data from the input interface describing second through Nth sets of acoustic artifacts, each of the sets of acoustic artifacts produced by state changes in the IMODs arising from the display of a corresponding reference graphic of the second through Nth reference graphics immediately prior to or immediately after the subject graphic;
compare each set of acoustic artifacts in the second through Nth sets of acoustic artifacts against the reference data, wherein:
the reference data is further associated with the second through Nth reference graphics, and
the authentication process is based in further part on the comparison of each set of acoustic artifacts in the second through Nth sets of acoustic artifacts against the reference data.

9. The apparatus of claim 8, wherein each of the first through Nth reference graphics differs from each of the other first through Nth reference graphics.

10. The apparatus of claim 8, the instructions further comprising instructions to control the at least one processor to cause only N−1 displays of the subject graphic in order to produce the first through Nth sets of acoustic artifacts.

11. The apparatus of claim 6, wherein:
the reference data includes data derived from acoustic artifacts produced by state changes in the IMODs arising from the display of the subject graphic by the IMOD display panel at a second time earlier than the first time, and
the authentication process authenticates the IMOD display panel.

12. The apparatus of claim 6, the apparatus further comprising an acoustic detector, the acoustic detector configured to:
detect the first set of acoustic artifacts, and
communicate data describing the first set of acoustic artifacts to the at least one processor via the input interface.

13. The apparatus of claim 6, the apparatus further comprising the IMOD display panel, wherein the at least one processor is communicatively connected with the IMOD display panel, the instructions further comprising instructions to control the at least one processor to cause the display of the subject graphic on the IMOD display panel.

14. The apparatus as recited in claim 13, further comprising a driver circuit configured to send at least one signal to the IMOD display panel.

15. The apparatus as recited in claim 14, further comprising an image source module configured to send image data for the subject image to the controller.

16. The apparatus as recited in claim 15, wherein the image source module includes at least one of a receiver, transceiver, and transmitter.

17. An apparatus comprising:
means for detecting a first set of acoustic artifacts produced by state changes in interferometric modulators (IMODs) of an IMOD display panel arising from the display of a subject graphic by the IMOD display panel at a first time;
means for comparing the first set of acoustic artifacts against reference data associated with the subject graphic; and
means for performing an authentication process based, at least in part, on the comparing to authenticate at least one of the subject graphic and the IMOD display panel.

18. The apparatus of claim 17, further comprising means for causing a display of a first reference graphic by the IMOD display panel immediately prior to or immediately after the display of the subject graphic, wherein the reference data is further associated with the first reference graphic and the first set of acoustic artifacts is produced by state changes in the IMODs arising from the display of the subject graphic immediately after the first reference graphic or from the display of the first reference graphic immediately after the subject graphic.

19. The apparatus of claim 18, further comprising:
means for causing displays of second through Nth reference graphics on the IMOD display panel, wherein N is an integer with a value of 2 or greater;
means for causing a display of the subject graphic on the IMOD display panel immediately prior to or immediately after the display of each of the second through Nth reference graphics;
means for receiving data from the input interface describing second through Nth sets of acoustic artifacts, each of the sets of acoustic artifacts produced by state changes in the IMODs arising from the display of a corresponding reference graphic of the second through Nth reference graphics immediately prior to or immediately after the subject graphic;
means for comparing each set of acoustic artifacts in the second through Nth sets of acoustic artifacts against the reference data, wherein:
the reference data is further associated with the second through Nth reference graphics, and
the authentication process is based in further part on the comparison of each set of acoustic artifacts in the second through Nth sets of acoustic artifacts against the reference data.

20. A machine-readable storage medium having software including computer-executable instructions stored thereon, the computer-executable instructions including instructions for controlling one or more processors to:
receive a first set of acoustic artifacts produced by state changes in interferometric modulators (IMODs) of an IMOD display panel arising from the display of a subject graphic by the IMOD display panel at a first time;
compare the first set of acoustic artifacts against reference data associated with the subject graphic; and
perform an authentication process based, at least in part, on the comparing to authenticate at least one of the subject graphic and the IMOD display panel.

21. The storage medium of claim 20, the computer-executable instructions further including instructions for controlling the one or more processors to cause a display of a first reference graphic by the IMOD display panel immediately prior to or immediately after the display of the subject graphic, wherein the reference data is further associated with the first reference graphic and the first set of acoustic artifacts is produced by state changes in the IMODs arising from the display of the subject graphic immediately after the first reference graphic or from the display of the first reference graphic immediately after the subject graphic.

22. The storage medium of claim 21, the computer-executable instructions further including instructions for controlling the one or more processors to:
cause displays of second through Nth reference graphics on the IMOD display panel, wherein N is an integer with a value of 2 or greater;
cause a display of the subject graphic on the IMOD display panel immediately prior to or immediately after the display of each of the second through Nth reference graphics;
receive second through Nth sets of acoustic artifacts, each of the second through Nth sets of acoustic artifacts produced by state changes in the IMODs arising from the display of a corresponding reference graphic of the second through Nth reference graphics immediately prior to or immediately after the subject graphic; and
compare each set of acoustic artifacts in the second through Nth sets of acoustic artifacts against the reference data, wherein:
the reference data is further associated with the second through Nth reference graphics, and
the authentication process is based in further part on the comparing each set of acoustic artifacts in the second through Nth sets of acoustic artifacts against the reference data.

23. An apparatus comprising:
an input interface;
an output interface; and
a controller operably connected with the input interface and the output interface, the controller comprising:
at least one processor, and
at least one memory, the at least one memory operably connected with the at least one processor and storing instructions executable by the at least one processor, the instructions comprising instructions to control the at least one processor to:
receive graphic content data via the input interface,
receive acoustic content data via the input interface, wherein the acoustic content data is independent of the graphic content data,
actuate, via the output interface, interferometric modulators (IMODs) in an IMOD display panel to:
display an image defined by the graphic content data, and
produce a time-varying number of acoustic artifacts correlating to the acoustic content data as the image is displayed.

24. The apparatus of claim 23, the instructions further comprising instructions to control the at least one processor to actuate the IMODs such that:
during each actuation cycle of the IMOD display panel, the number of acoustic artifacts produced by IMOD actuations in the cycle correlates with a portion of the acoustic content data,
portions of the image are displayed by IMODs during each actuation cycle,
the portions, in aggregate, form the image, and
all of the portions of the image are displayed over a time frame of about 60 ms or less.

25. The apparatus of claim 23, the instructions further comprising instructions to control the at least one processor to actuate the IMODs such that:
the image is displayed across a first region of the IMOD display panel during a first set of actuation cycles for the IMOD display panel, and
the IMODs in a second region are, while the image is displayed across the first region, actuated during a second set of actuation cycles to produce the time-varying number of acoustic artifacts correlating to the acoustic content data, the second region separate from the first region and the second set of actuation cycles separate from the first set of actuation cycles.

26. The apparatus of claim 25, wherein:
the first region includes an interior region of the IMOD display panel, and
the second region includes a peripheral region of the IMOD display panel.

27. A machine-readable storage medium having software including computer-executable instructions stored thereon, the computer-executable instructions including instructions for controlling one or more processors to:
receive graphic content data via the input interface,
receive acoustic content data via the input interface, wherein the acoustic content data is independent of the graphic content data,
actuate, via the output interface, interferometric modulators (IMODs) in an IMOD display panel to:
display an image defined by the graphic content data, and
produce a time-varying number of acoustic artifacts correlating to the acoustic content data as the image is displayed.

28. The storage medium of claim 27, the computer-executable instructions further including instructions for controlling the one or more processors to actuate the IMODs such that:
during each actuation cycle of the IMOD display panel, the number of acoustic artifacts produced by IMOD actuations in the cycle correlates with a portion of the acoustic content data,
portions of the image are displayed by IMODs during each actuation cycle,
the portions, in aggregate, form the image, and
all of the portions of the image are displayed over a time frame of about 60 ms or less.

29. The storage medium of claim 27, the computer-executable instructions further including instructions for controlling the one or more processors to actuate the IMODs such that:
the image is displayed across a first region of the IMOD display panel during a first set of actuation cycles for the IMOD display panel, and
the IMODs in a second region are, while the image is displayed across the first region, actuated during a second set of actuation cycles to produce the time-varying number of acoustic artifacts correlating to the acoustic content data, the second region separate from the first region and the second set of actuation cycles separate from the first set of actuation cycles.

30. The storage medium of claim 29, wherein:
the first region includes an interior region of the IMOD display panel, and
the second region includes a peripheral region of the IMOD display panel.
